(19) United States
(12) Patent Application Publication
(10) Pub. No.: US 2025/0225375 A1
(43) Pub. Date: Jul. 10, 2025

(54) MACHINE LEARNING SYSTEMS AND TECHNIQUES FOR AUDIENCE-TARGETED CONTENT GENERATION

(71) Applicant: Adobe Inc., San Jose, CA (US)

(72) Inventors: Shubham Lohiya, Atlanta, GA (US); Meghanath M y, San Jose, CA (US); Varsha Sankar, Mountain View, CA (US); Luiz Fernando Teixeira Maykot, Atlanta, GA (US); Debraj Debashish Basu, Sunnyvale, CA (US); Deepak Pai, Sunnyvale, CA (US)

(73) Assignee: Adobe Inc., San Jose, CA (US)

(21) Appl. No.: 18/409,250

(22) Filed: Jan. 10, 2024

(51) Int. Cl. G06N 3/0455; G06F 40/40; G06N 3/092

(52) U.S. Cl. CPC G06N 3/0455; G06F 40/40; G06N 3/092

(57) ABSTRACT

Embodiments are generally directed to extending artificial intelligence (AI) and machine learning (ML) techniques to generate content predicted to elicit a performance response from an intended recipient of a target audience. One method of generating content includes determining content generation information from a user prompt, the content generation information comprising a subject, an audience segment, and a performance indicator; and providing the content generation information to a content generation model to generate at least one item of audience-targeted content corresponding to the subject targeted to the audience segment to elicit a response defined by the performance indicator, wherein the content generation module comprises a natural language processing (NLP) model trained, via a content generation training module, using reinforcement learning based on a reward of a performance prediction determined by a performance prediction model based on historical performance data.

### BACKGROUND

Content distributers often publish visual and/or textual content with an intended objective. For example, a marketing firm may intend to send emails that will obtain a target click rate for a link in the email. In another example, an educational services company may seek to provide learning materials that are memorable for students. The impact of content is often determined based on the characteristics of the particular recipient or the entire audience segment, such as age, experience, interests, and/or the like. However, creating content designed to resonate with particular audiences using existing technologies is very costly and time consuming, and, overall, is not sufficiently accurate to justify the costs. As a result, content developers using existing technologies typically rely on manually re-creating different versions of content for different audience segments or simply send the same content to different audiences.

There are some tools for automated content generation based on developer instructions. However, these tools require significant domain expertise and prompt engineering. In addition, current automated tools are not able to generate effective, audience-based content because, among other reasons, they do not leverage audience interaction information or performance (e.g., key performance indicators (KPI)) optimization. As a result, existing automated content development tools do not scale and, ultimately, are not effective. Accordingly, developers lack sufficient technologies to generate content targeted to multiple different audience segments that will obtain an intended objective.

### SUMMARY

Embodiments are generally directed to extending artificial intelligence (AI) and machine learning (ML) techniques to generate content. More specifically, embodiments are directed to a machine-learning based approach that learns to predict the performance of content for particular audience segments.

Some embodiments provide a content generation system configured to generate content for a targeted audience configured to elicit a particular recipient response. The content generation system uses AI/ML models trained by learning both consumer and content embeddings from historical interaction data across different modalities (e.g., numeric data, such as quantifiable content interactions (clicks, reads, interaction duration, etc.), product interactions, product downloads; text data, such as segment labels, surveys and survey interactions; categorical or demographic data, such as geography, funnel stage, age, experience, education, income level, gender, and/or the like). The trained AI/ML models operate to score the pairing of content and audience segment based on one or more specific performance objectives (e.g., KPIs) and, in some embodiments, refines a language model (e.g., LLM) using reinforcement learning to generate content. The AI/ML architecture configuration and training processes according to some embodiments produce models configured to learn to generate content that scores highly on performance objectives of interest for specific audience segments.

Any of the above embodiments may be implemented as instructions stored on a non-transitory computer-readable storage medium and/or embodied as an apparatus with a memory and a processor performs the actions described above. It is contemplated that these embodiments may be deployed individually to achieve improvements in resource requirements and library construction time. Alternatively, any of the embodiments may be used in combination with each other in order to achieve synergistic effects, some of which are noted above and elsewhere herein.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example system in accordance with embodiments described in the present disclosure.

FIG. 2 illustrates an example of a processing flow in accordance with embodiments described in the present disclosure.

FIG. 3 illustrates features of the subject matter in accordance with embodiments described in the present disclosure.

FIG. 4 illustrates an example of a processing flow in accordance with embodiments described in the present disclosure.

FIG. 5 illustrates features of the subject matter in accordance with embodiments described in the present disclosure.

FIGS. 6A and 6B illustrate features of the subject matter in accordance with embodiments described in the present disclosure.

FIG. 7 illustrates an example of a processing flow in accordance with embodiments described in the present disclosure.

FIG. 8 illustrates features of the subject matter in accordance with embodiments described in the present disclosure.

FIGS. 9A-9C illustrate features of the subject matter in accordance with embodiments described in the present disclosure.

FIG. 10 illustrates features of the subject matter in accordance with embodiments described in the present disclosure.

FIG. 10 illustrates a routine in accordance with embodiments described in the present disclosure.

FIG. 11 illustrates a routine in accordance with embodiments described in the present disclosure.

FIG. 12 illustrates a routine in accordance with embodiments described in the present disclosure.

FIG. 13 illustrates a routine in accordance with embodiments described in the present disclosure.

FIG. 14 illustrates a system in accordance with one embodiment.

FIG. 15 illustrates an apparatus in accordance with one embodiment.

FIG. 16 illustrates an artificial intelligence architecture in accordance with one embodiment.

FIG. 17 illustrates an artificial neural network in accordance with one embodiment.

FIG. 18 illustrates a computer-readable storage medium in accordance with one embodiment.

FIG. 19 illustrates a computing architecture in accordance with one embodiment.

FIG. 20 illustrates a communications architecture in accordance with one embodiment.

### DETAILED DESCRIPTION

Embodiments are directed to a machine-learning based approach to generating digital content targeted to a specific audience and to prompt a particular recipient response. In some embodiments, a performance prediction model is trained with a data triad of audience, content, and recipient responses to the content to predict audience interaction with content. The trained performance prediction model is used as a reward function for a reinforcement learning process to train and/or tune a content generation model configured to generate content for one or more audience segments, for instance, to obtain a designated objective, such as prompting a particular recipient response for the content.

The performance prediction model is trained to learn how different audience segments interact with different configurations of content. Training data used to train the performance prediction model includes results of real-world interactions of multiple audiences with different configurations of content that were developed to elicit certain objectives with the content (e.g., reading the content, clicking on a link in the content, and/or the like). For example, a first marketing email for a product with a first subject line is read by a significant number of members of a first audience segment (e.g., professional programmers, aged 25-35 years old), while being largely ignored by members of a second audience segment (e.g., novice programmers, aged 25-35 years old). However, a second marketing email for the same product with a second subject line is read by a greater number of members of the second audience segment and a smaller number of users of the first audience.

In operation, the performance prediction model receives content (e.g., an email, text, video, images, and/or the like) and an audience segment (e.g., content recipients segmented based on one or more characteristics, such as age, experience, geographic location, device, and/or the like) as input. The performance prediction model generates output in the form of a prediction of whether an audience member will perform an action with the content (e.g., a key performance indicator (KPI), such as reading/viewing the content, clicking on a link in the content, memorability of the content, and/or the like). For example, given an email advertising a product or service (e.g., a hotel) and a specified audience of a consumer segment (e.g., individuals that have previously stayed at a property of the hotel brand), the performance prediction model generates a prediction of whether a recipient of the email will click on a link in the email to visit the hotel website.

In various embodiments, the performance prediction model includes, without limitation, one or more of a language model, a large language model (LLM), a network (e.g., a neural network, an artificial neural network, a feedforward artificial neural network, a perceptron, a multi-layer perceptron (MLP)), a transformer, combinations thereof, variations thereof, and/or the like.

The content generation model is trained to generate content that will achieve a performance objective for a particular audience. In some embodiments, the content generation model is or includes an LLM. In general, any LLM having weights capable of being modifiable by an operator or developer may be used. Non-limiting examples of LLMs include a version of the LLaMA model provided by Meta Platforms, Inc. and a version of the Mistral model provided by Mistral AI. In various embodiments, the content generation model is trained and/or tuned using reinforcement learning (RL) techniques. The RL techniques can be performed with or without human feedback (HF) (RLHF). In some embodiments, RL is achieved using direct preference optimization (DPO) or proximal policy optimization (PPO).

In various embodiments, the RL reward mechanism for training the content generation model is or is based on the trained performance prediction model. For example, within the RL process, the content generation model generates content, which is provided as input to the performance prediction model. The output of the performance prediction model (e.g., a prediction value or score) is used as an indicator of the quality of the content created by the content generation model for prompting one or more recipient responses to the content (i.e., a probability that the content will meet the specified performance object). Through successive iterations, the content generation model learns to generate content with increasing prediction values (i.e., more likely to meet performance objectives).

In operation, the content generation model receives a subject (e.g., a product, a service, instructional information, and/or the like), an audience segment (e.g., content recipients segmented based on one or more characteristics, such as age, experience, geographic location, device, and/or the like), and a performance objective (e.g., a key performance indicator (KPI), such as reading/viewing the content, clicking on a link of the content, memorability of the content, and/or the like) as input.

Based on the received input, the content generation model generates output in the form of content relating to the subject that is directed to cause a recipient of the target audience to perform the performance objective. For example, given a subject of a graphic design software application, a target audience of experienced graphic designers, and a performance objective of visiting a website of a vendor of the graphic design software application, the content generation model generates a first marketing video with content predicted by the performance prediction model to cause a recipient of the target audience to visit the vendor website. For the same graphic design software application but a different target audience, such as novices in the general public, the content generation model generates a second marketing video with content predicted by the performance prediction model to cause a recipient of that particular target audience to visit the vendor website, which is different from the content of the first marketing video.

Although marketing or advertisement content, marketing campaigns, and/or other marketing-related examples are used in the present disclosure, embodiments are not so limited, as marketing-related examples are used for illustrative purposes only. Other types of content, including, without limitation, educational content, instructional content, and entertainment content, may also be used in various embodiments described in the present disclosure.

Providing the right content to the correct user is a main goal of content developers. Often developers desire for recipients to have a specific response to the content, such as performing certain actions. For example, for instructional content, a developer may seek to have a recipient read through the entirety of the instructions, pass a test on the information, follow the instructions, and/or the like. In another example, for a marketing message, a developer may desire to have a recipient visit a website, make a purchase, and/or the like. In a further example, for entertainment content, an objective of a developer may be for content viewers to watch the content in its entirety.

Key performance indicators (KPI) generally include defined, quantifiable targets, objectives, actions, and/or the like for content. For example, for video content distributed via a video sharing site, such as YouTube®, a KPI may include watching the video, watching a specific duration of the video, sharing the video, subscribing to the content creator, visiting a website linked or displayed in the video, and/or the like. In another example, for a SMS or text message, a KPI may include viewing the text message, responding to the text message, visiting a website in the text message, absence of a “stop” or “do not contact” reply to the text message, and/or the like.

Creating KPI performant content that resonates with distinct audience segments using conventional technologies is challenging and time consuming. Content developers often want their message to reach diverse audiences. For example, soft drink marketers want to advertise to a wide range of demographics, such as the typical age brackets of 18-24 year olds, 25-34 year olds, 35-44 year olds, 45-54 year olds, 55-65 year olds, and 65 years old and older. In another example, an instructional content developer, such as content relating to network security at large corporations, needs to provide effective content for experienced users (e.g., IT personnel) all the way through inexperienced employees. However, interaction with the content for each different audience segment will be different. Accordingly, in order to optimize the impact of their messaging, developers desire to provide different content to different audiences. Currently though, content developers rely on manually creating different versions of different content for different segments, if they do it at all. With existing technologies, audience-specific targeting of content is a very time consuming and expensive endeavor. Accordingly, many developers simply create one (or two) messages and send them to all segments instead of creating audience-specific content.

Advances in ML, such as automated text generation, have enabled content creators to probe natural language processing (NLP) models, such as LLMs, via prompt engineering for generating elements of content, such as an email subject line or call to action for an email campaign. Examples of text generation models include GPT-3.5, GPT-4, Bard, Bing, Claude, Typeface, EmailDojo, CopyAI, and/or the like. However, existing ML platforms are not able to extend prompt-initiated content creation for specific audience segments with the goal of delivering on performance objectives. Such tasks are still laborious with ML chat-bots, language models (including LLMs), and other prompt-based ML models, which do not scale, particularly to be useful for enterprise applications. In-context learning, retrieval augmented generation, and other techniques can mitigate some of the bottlenecks of existing ML models by exemplary demonstrations of a current task. However, current ML methods are limited by the scope of training data and an understanding of real-world context, for instance, of the relationship of content to audience segments and further to performance objectives, to allow current ML methods to be unusable for actual enterprise applications.

Although existing ML models can offer services for generating content, audience-specific personalization and targeting for specific performance objectives is not practical, or even possible in most systems, as these ML models are limited by requiring significant domain expertise and complex prompt engineering to even attempt such functionality. For example, existing systems, even ML-based systems, do not leverage content interaction data (e.g., based on whether performance objectives were met for certain content for specific audience segments) and do not have an optimization strategy focused on content targeting and personalization focused on specific performance objectives. As a result, existing content creation systems are not capable of grounding audience segment data across different modalities (e.g., textual information, such as country/state/town of origin, numeric features such as hours of usage with a specific technology or software platform, and/or the like) to generate audience-specific performance objective content at scale.

Accordingly, some embodiments provide a content generation system configured to generate content for a targeted audience configured to elicit a particular recipient response. The content generation system uses AI/ML models trained by learning both consumer and content embeddings from historical interaction data across different modalities (e.g., numeric data, such as quantifiable content interactions (clicks, reads, interaction duration, etc.), product interactions, product downloads; text data, such as segment labels, surveys and survey interactions; categorical or demographic data, such as geography, funnel stage, age, experience, education, income level, gender, and/or the like). The trained AI/ML models operate to score the pairing of content and audience segment based on one or more specific performance objectives (e.g., KPIs) and, in some embodiments, refines a language model (e.g., LLM) using reinforcement learning to generate content. The AI/ML architecture configuration and training processes according to some embodiments produce models configured to learn to generate content that scores highly on performance objectives of interest for specific audience segments.

The content generation system is configured as a tool for content creators to produce content (including the efficient and effective development of vast amounts of content) tailored to specific audience segments, while also facilitating desired performance objectives for the content. For example, the content generation system can allow a marketer to generate multiple email campaigns to increase a particular KPI (e.g., click rate) for a specific software product (e.g., photo editing suite) across various consumer segments (e.g., professional, experienced, non-experienced, prior user, and/or the like). The AI/ML architecture of the content generation system allow developers to easily and efficiently create content that is higher quality and more relevant and persuasive to target audiences compared with existing systems, which, overall, facilitates the creation of content that possesses higher potential for achieving desired performance objectives.

As used herein, “content” or any variations thereof refers to any type of visual, graphical, textual, auditory, combinations thereof, and/or the like information for presentation to a recipient. Non-limiting examples of content include digital media, any website, any email, any graphic, any video, any image, any audio, any text, any computer program, and/or any other form of information and/or any combinations thereof.

As used herein, a “language model” refers to a deep learning AI algorithm configured to perform natural language processing (NLP) tasks using transformer models and/or neural networks (NNs) trained using massive data sets to recognize, predict, or generate text based on language input. A non-limiting example of an NLP model is a large language model (LLM), such as the LLaMA LLM provided by Meta Platforms, Inc. or the Mistral model provided by Mistral AI.

As used herein, “reinforcement learning” is an AI/ML model training technique that uses a reward (or trial-and-error) feedback system to improve the output of the AI/ML model. Non-limiting examples of reinforcement learning include policy gradient processes (for instance, deep deterministic policy gradient (DDPG)), state-action-reward-state-action (SARSA), Deep Q-Learning (DQL), Vanilla Policy Gradient Algorithm (VPG), Trust Region Policy Optimization (TRPO), proximal policy optimization (PPO), direct preference optimization (DPO), and reinforcement learning from human feedback (RLHF).

As used herein, an “audience segment” is a segment, division, group, or other collection of individuals intended to receive or access content. An audience segment can be defined or divided on various characteristics, including, without limitation, age, gender, income, education, occupation, experience level, exposure (e.g., to content, a product, and/or the like), associated devices, software downloads, associated content consumption mediums and/or platforms, and/or the like.

As used herein, a “performance objective” is an action taken by a recipient or viewer with content. A non-limiting example, of performance objectives include key performance indicators (KPIs), such as reading content, opening an email, clicking on a link, visiting a website, replying to a survey, survey responses, and/or the like.

As used herein, a “performance prediction” is a prediction of whether an intended recipient or viewer of content will perform a performance objective. For example, a performance prediction can be a numerical value representing a probability that a content recipient will perform a KPI with the content (for instance, a performance prediction of 0.5 for a “click” KPI represents a 50% probability that a recipient will open an email and click on a link in the email).

Embodiments provide a content generation system configured to generate content targeted for specific audiences and configured to elicit a specific response from recipients. The embodiments provide several advantages and benefits relative to conventional techniques, including existing AI/ML techniques. For example, content creation techniques suffer from at least the following key challenges: (1) the inability to simulate the effectiveness of content for a particular audience segment for a specific performance objective before it is released; (2) the absence of an AI/ML solution specifically configured for generating personalized content configured to elicit a specified recipient response; (3) the inability to determine features of a specific item of content that directly affect the ability of the item of content to prompt a desired performance objective; and (4) require the use of large-scale and resource-intensive AI/ML platforms.

With respect to the first challenge, embodiments implement a content generation system that includes an AI/ML architecture configured to predict the effectiveness of content at eliciting a specific response (e.g., a KPI, such as reading an email or clicking on a link in the content). The response prediction is used to train, for instance, in an RL process, a language model to receive a subject, an audience segment, and a performance objective as input, and to generate content targeted to cause the audience segment to interact with the content and carry out the performance objective. The AI/ML architecture allows a user to simulate viewer responses to generated content before publishing the content to the public. With conventional systems, content creators were limited to relying on viewer surveys and/or tracking user online behavior after the content had been distributed, and then attempting to design future content based on this information. However, the AI/ML architecture allows a developer to simulate audience responses to content and modify, fine-tune, enhance, and/or the like the content to obtain specific objectives prior to incurring the time and const of launching the content.

With respect to the second challenge, the AI/ML architecture includes a performance prediction AI/ML model trained on a data triad of audience, content, and recipient responses to the content to predict audience interaction with content. Accordingly, the AI/ML architecture is able to predict audience-specific performance objectives for content, such as an email, website, or video. The trained performance prediction model is then used as a reward function for an RL process to train and/or tune a content generation model configured to generate content for one or more audience segments, for instance, to obtain a designated objective, such as prompting a particular recipient response for the content. Existing AI/ML solutions are merely able to generate text or other content based on a prompt that is not able to predict a performance objective for a specific audience segment for the content.

With respect to the third challenge, the AI/ML architecture provides performance objective prediction feedback for specific items of content, such as a prediction score, that provides creators with an understanding of factors that make content more likely to elicit a desired response for a specific audience segment, and thus, helps creators create better designs. Existing solutions are merely able to provide broad guidelines that applied generally to content (e.g., call to action terms, email subject lines, etc.). Using the AI/ML architecture according to some embodiments, a user receives a performance objective prediction score specialized for their particular item of content, audience segment, and performance objective, which allows developers to makes changes to the content (or content generation prompt) to generate a new (higher) score to increase the potential for achieving a performance objective of the content before distribution.

With respect to the third challenge, the AI/ML architecture uses AI/ML models, such as language models, with trainable parameters on the order of millions (for instance, about 5 million to about 10 million) in its operational, inference phase. This number of parameters is significantly less than required by AI/ML models capable of performing relevant language/content processing, such as GPT-3.5 Turbo. In some examples, AI/ML models according to some embodiments use only a fraction of the parameters of relevant existing AI/ML models, such as about 4% or even 0.15% (e.g., 8.4 million out of 7 billion) the number of parameters of a base language model, for example, due to the use of a low-rank adapter. Accordingly, the AI/ML architecture is able to perform functions according to some embodiments with a much smaller resource footprint.

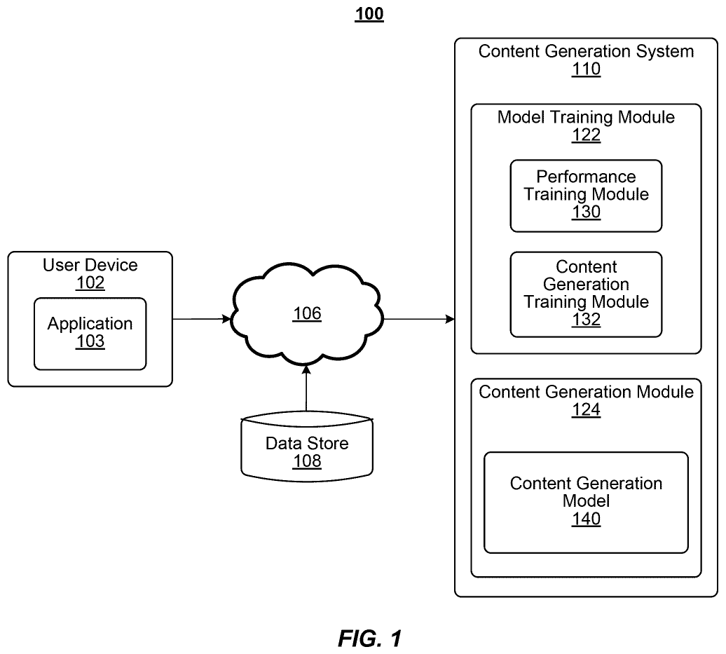

FIG. 1 illustrates an example embodiment of a system 100 that performs the operations discussed herein. The system 100 includes additional systems and computing components to perform various operations. In one example, the system 100 includes a content generation system 110 including components or modules to perform operations for generating audience-targeted content configured to elicit performance objectives from recipients. These modules include a model training module 122 and a content generation module 124. Each of the modules performs one or more operations to configure, train, and/or tune at least one model, process user prompts to create audience-targeted, performance-based content, and to simulate the performance of the content with the targeted audience for eliciting a response objective.

In various embodiments, the content generation system 110 implements or inferences an AI/ML based approach that learns to predict performance objectives for content by leveraging historical performance objective data and language models trained with the content, audience segment, and performance information and tuned specifically to generate performance predictions based on the elements of the content and the audience segment accessing the content. In some embodiments, the content generation system 110 implements or inferences an AI/ML approach that learns to generate content to achieve performance objectives for a specific audience segment based on, for example, reinforced learning using outputs of a trained performance objective prediction model.

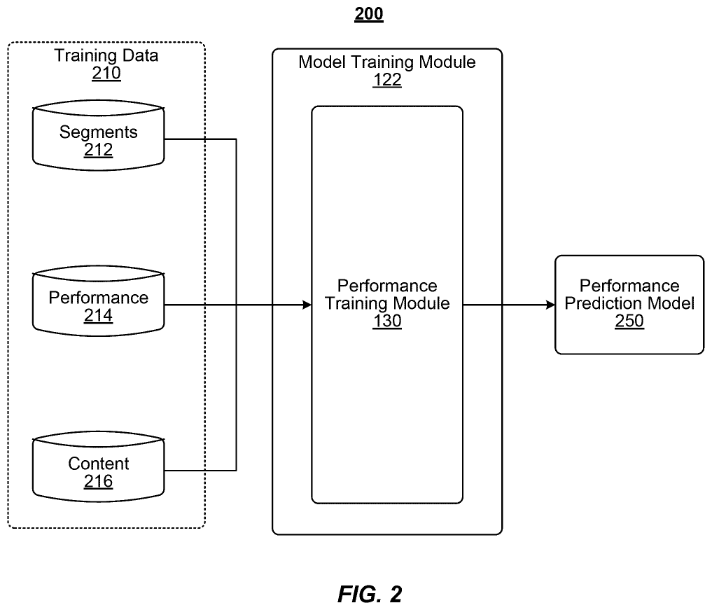

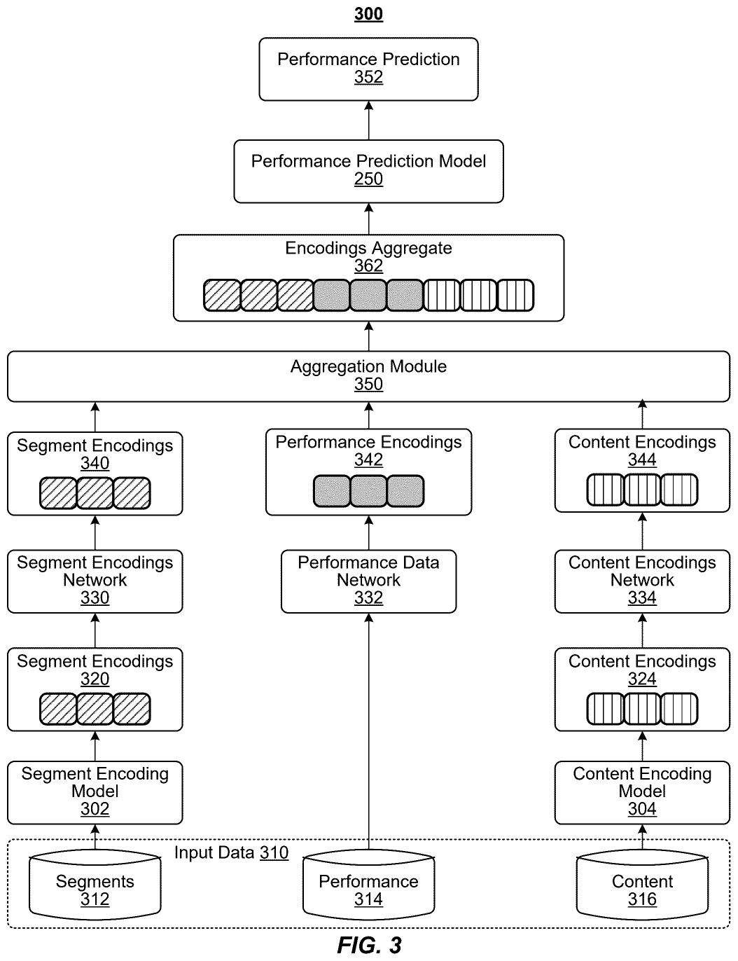

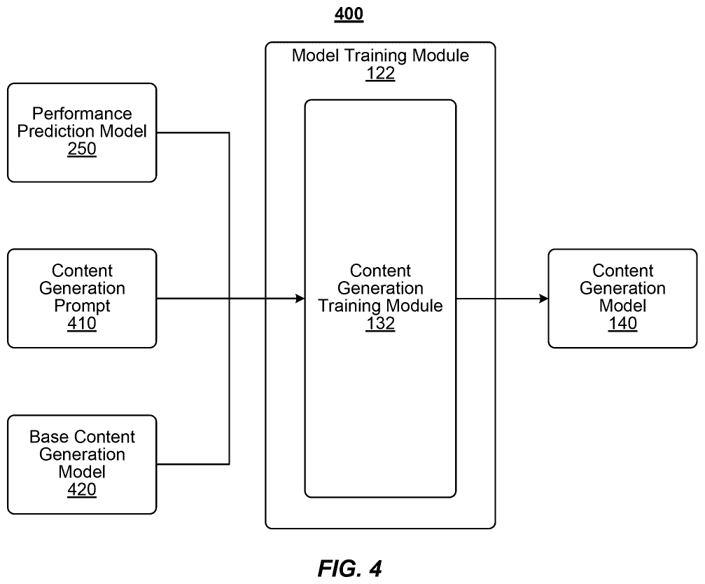

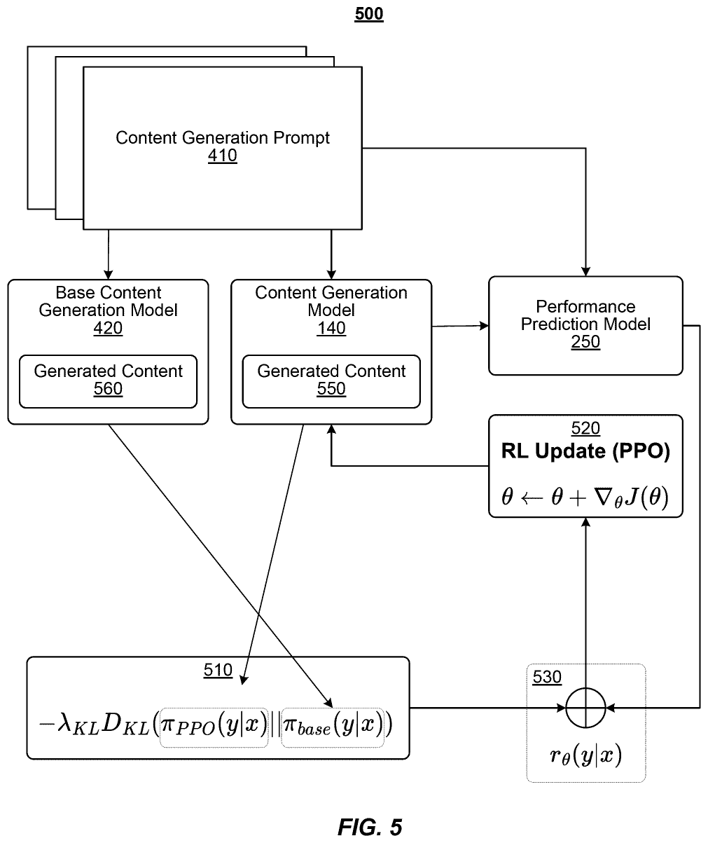

In some embodiments, the model training module 122 operates to configure one or more AI/ML models of the content generation system 110. The configuration of AI/ML models includes model training, tuning, and/or the like. In some embodiments, the model training module 122 includes a performance training module 130 configured to train a language model, AI/ML networks, and/or the like to predict the performance of content for a specific audience segment (e.g., a prediction of the click rate of a link in an email sent to consumers aged 35-45 years old) (see, for example, FIGS. 2 and 3). In various embodiments, the model training module 122 includes a content generation training module 132 configured to train a language model to generate content based on reinforcement learning using the performance prediction model trained via the performance training module (see, for example, FIGS. 4 and 5).

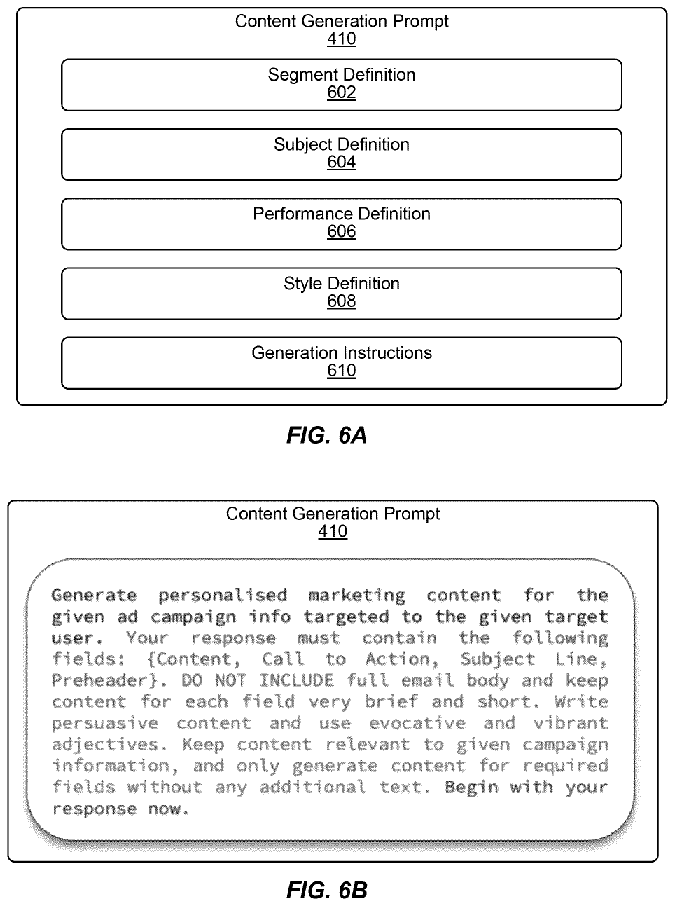

The content generation module 124 is configured to generate content, for instance, based on a user input prompt that is targeted to a specific audience segment and to elicit a performance objective. The content generation module 124 includes a content generation model 140 (see, for example, FIG. 5) configured to receive a user prompt with instructions for generating content (see, for example, FIGS. 6A and 6B). Non-limiting examples of instructions include a segment definition (e.g., defining the target audience segment), a subject definition (e.g., the focus of the content, such as a product or service, a website, text or graphics to include in the content, and/or the like), a performance definition (e.g., one or more performance objectives desired for content recipients, such as viewing the content, opening an email, responding to an email, clicking on a link, a content interaction duration, and/or the like), a style definition (e.g., information specifying the style, tone, and/or the like of the content, content guidelines (e.g., marketing or corporate style guidelines), generation instructions (e.g., specifying fields of content, such as email subject, call to action, and/or the like, and/or any other information that may be relevant to creating the content), and/or the like.

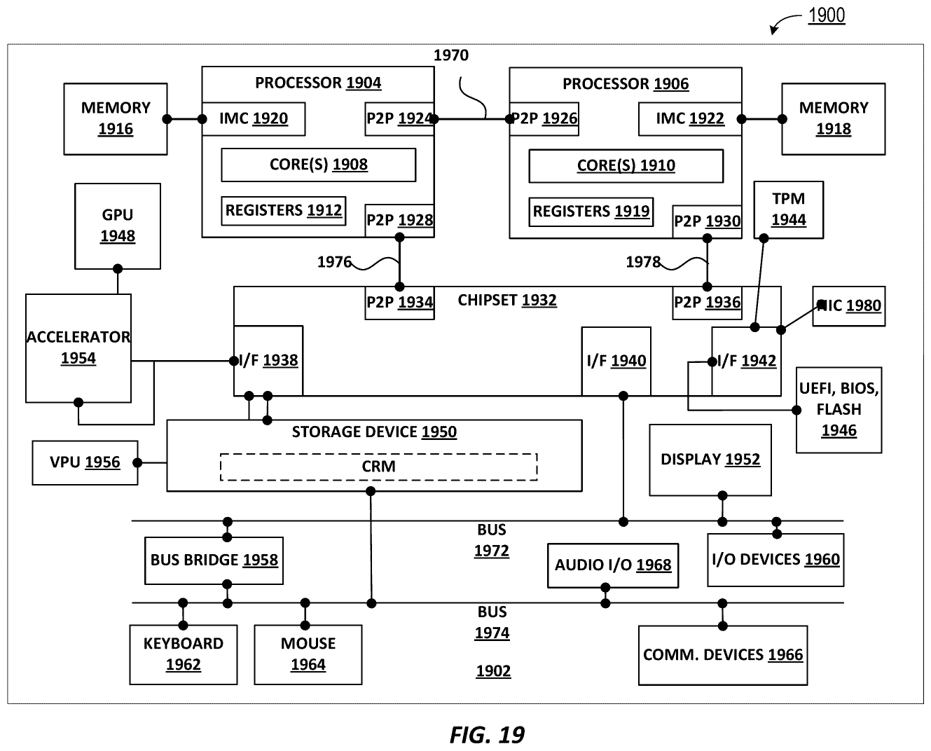

The system 100 includes a user device 102 configured to communicate with the content generation system 110, for example, via a network 106, which may include, without limitation, one or more local area networks (LANs), wide area networks (WANs), the internet, a wired or wireless network, and/or the like. Each of the user device 102 and content generation system 110 shown in FIG. 1 can comprise one or more computer devices, such as the computing architecture 1900 of FIG. 19. It should be understood that any number of user devices 102 and content generation systems 110 may be employed within the system 100 within the scope of the present disclosure. Each of the user device 102 and the content generation system 110 may comprise a single device or multiple devices cooperating in a distributed environment. For instance, the content generation system 110 could be provided by multiple server devices collectively providing the functionality of the content generation system 110 as described in the present disclosure. Additionally, other components not shown may also be included within the environment of network 106.

The user device 102 can be any type of computing device, such as, for instance, a personal computer (PC), tablet computer, desktop computer, mobile device, smartphone, tablet device, or any other suitable device having one or more processors. As shown in FIG. 1, the user device 102 includes an application 103 for interacting with the content generation system 110. The application 103 can be, for instance, a web browser or a dedicated application for providing functions, such as those described in the present disclosure. In some embodiments, the application 103 may comprise some or all components of the content generation system 110. While the content generation system 110 is shown separate from the user device 102 in the configuration of FIG. 1, it should be understood that in other configurations, some or all of the functions of the content generation system 110 can be provided on the user device 102. For instance, in some embodiments, the content generation system 110 is provided entirely on the user device 102.

In some embodiments, the content generation system 110 is or is a part or feature of a content creation, distribution, and/or publication platform. For example, a content design or creation application can provide a feature for predicting content performance objectives for content and/or user prompts. In another example, a content design application can provide a feature for generating content based on user prompts. For instance, during or after designing an item of content, a user executes a performance objective analysis (e.g., a prediction of how likely a recipient will interact with the content according to the performance objective, such as clicking a link in the content, opening an email, and/or the like) for the item of content from within the content creation application. Based on the performance objective analysis, the user can continue to design or edit the item of content prior to distribution. In another instance, a user can enter a prompt defining certain parameters of the content (e.g., a subject, text, delivery form (such as an email, a website, a video, a graphical image, and/or the like), a style, content guidelines, and/or the like), an audience segment, and a performance objective, and the content creation application generates content targeted for the audience segment and configured to elicit the performance objective. In other embodiments, the content generation system 110 is a standalone application configured to receive visual content input generated by an external application (i.e., visual content files are uploaded to the content generation system 110).

FIG. 2 illustrates an example of a processing flow in accordance with embodiments described in the present disclosure. More specifically, FIG. 2 illustrates an example of a processing flow 200 for training a performance prediction model 250. As shown in FIG. 2, model training module 122 includes a performance training module 130 configured to access training data 210. In various embodiments, the training data 210 includes segments training data 212, performance training data 214, and content training data 216. In some embodiments, the training data 210 is or includes real-world training data of content sent to different audience segments and the resulting performance objectives. For example, the training data 210 can include a first marketing email for a first software platform sent to a first group of an audience segment (e.g., experienced professionals aged 25-35) with the desired performance objective of clicking on a link in the email and the actual performance objective results (e.g., a 50% click rate). In another example, the training data 210 can include a second marketing email for the first software platform (with different text and/or content configuration than the first marketing email) sent to a second group of the audience segment with the desired performance objective of clicking on a link in the email and the actual performance objective results (e.g., a 70% click rate).

In some embodiments, the segments training data 212 includes data associated with different audience segments defined based on one or more characteristics. Non-limiting characteristics include age, gender, geographic region, income level, education, employment, number of hours of experience or interaction (e.g., with a product, an occupation, training, an entertainment platform, a streaming service, and/or the like), health condition, occupation, vocation, marriage status, number of children, exercise activity, device use or ownership, and/or any other property of interest that can be used to segment an audience. For example, an audience can be segmented into a first segment of iPhone® owners and a second segment of Android™ device owners. In another example, the audience can be segmented into a first group of iPhone® owners that are experienced users of Application A (e.g., have used Application A for over 50 hours), a second group of iPhone® owners that are novice users of Application A (e.g., have used Application A for less than 20 hours), a third group of iPhone® owners that do not use Application A.

In some embodiments, the segments training data 216 includes the actual content and/or data associated the content sent to various audience segments, such as recipients of the segments training data 216. In exemplary embodiments, the content training data 216 includes emails, websites, text, graphics, files, images, and/or the like. In some embodiments, the content training data 216 includes context information for the content, such as style properties, guidelines used in making the content (e.g., restrictions, limitations, suggested verbiage, and/or the like), descriptions of the content, changes to the content, and/or the like.

In various embodiments, the performance training data 214 includes the historical, real-world results of performance objectives associated with the content. For example, the performance training data 214 can include the click rate, read rate, interaction duration, completion rate, test results (e.g., tests on material in educational/training content), and/or the like.

The training data 210 is fed into the performance training module, with each pool of training data 212, 214, and 216 taking a different training path to produce the trained performance prediction model 250 (see, for example, FIG. 3). The performance prediction model 250 learns both audience (e.g., training data 212) and content (e.g., training data 216) embeddings from historical interaction data (e.g., training data 216) across different modalities (e.g., product interactions (such as user activity within a software application or email), product downloads, text, segment labels, surveys, marketing funnel stage, and/or the like). The performance prediction model 250 is trained to score the pairing of content and audience segment to predict the likelihood of a recipient performing a performance objective.

In one example, the training data 210 includes an email campaign marketing a software product that tracked the click rate of recipients. For instance, the training data 210 can include 100 email campaigns, each of which includes a set of specific features (e.g., about 15 features), such as content elements, intent, linked products, subject lines, and/or the like. In this example, the performance prediction model 250 is trained to predict the click rate of emails based on the content of the emails (e.g., content elements, such as the header, subject, body, call to action, time of receipt of email, and/or the like) and/or the audience segment of recipients. In another example, the training data includes educational material (e.g., a slide show, document, video, and/or the like) and the tracked performance objectives were duration of time with the material (e.g., how long did recipients read, watch, or otherwise interact with the material, KPIs, and/or the like). In this example, the performance prediction model 250 is trained to predict the duration of time that a recipient will interact with the material based on the elements of the content and/or the audience segment of recipients.

In some examples, the training data 210 includes millions of recipients, consumers, or other types of audience members, with each audience member associated with a plurality of distinct characteristics, properties, or other attributes. For instance, the training data 210 can include about 5.6 million individuals, each with about 1400 attributes. The attributes can include numerical information, such as product interactions, product downloads, clicks, interaction duration, and/or the like. The attributes can include categorical information, such as age, geographic information, gender, income level, spending habits, education, occupation, vocation, marketing/purchasing funnel stage, received information (e.g., the marketing campaigns, educational materials, etc. the individual has been exposed to), customer segment labels, and/or the like. In some examples, the training data 210 and/or the attributes of an audience member is from or is derived from public information, such as the Yale University Open Data Access Project (YODA).

FIG. 3 illustrates features of the subject matter in accordance with embodiments described in the present disclosure. More specifically, FIG. 3 depicts an AI/ML architecture for performance prediction model 250.

As shown in FIG. 3, the input data 310 is provided to the performance prediction model 250 as a segment 312, content 316, performance 314 triad, with each type of data being fed into a distinct path within the AI/ML architecture 300. Each type of data of the triad is processed into data individual encodings and then aggregated into a single encoding (e.g., encodings aggregate 362) that is then provided to the performance prediction model 250 to generate a performance prediction 352.

During a training phase, the input data 310 is training data 210. During an operational or inference phase, the input data 310 can be a user prompt (see, for example, FIGS. 6A and 6B) or other input specifying content. In one example, during a training phase of an email campaign for a software product, information is extracted from the training data 210 and separated into segments 312 (e.g., the specific audience segments the content was sent to), performance 314 (e.g., the performance objectives and historical results data), and content 316 (e.g., text, graphics, content form or delivery method, and/or the like). Each of segments 312, 314, and 316 are fed through a different path in the AI/ML architecture 300 (e.g., a segment path, a performance path, and a content path).

In some embodiments, the performance prediction model 250 is supervised with paired or otherwise related data (e.g., the segment, performance, content data triad). The AI/ML architecture 300 is flexible to accommodate varying modalities of segment and content data (e.g., numerical, categorical, unstructured text, graphics, video, and/or the like). In some embodiments, for graphics and/or video content, the data is pre-processed into textual data (for instance, via an image-to-text language model or LLM). For instance, the image or video data can be processed via a visual encoder or other AI/ML model trained to generate visual embeddings that represent the content and visual features of an input image (or images extracted from a video). A non-limiting example of a visual encoder is a vision transformer (ViT) model, which is a NN pre-trained on image-text pairs to generate visual embeddings based on image input. Non-limiting examples of ViTs include Contrastive Language-Image Pre-Training (CLIP) and (Explore the limits of Visual representation at scAle) EVA-CLIP.

In some embodiments, during a training phase, the input data 310 may be from a single training set, split into the different categories or training sets 312, 314, and 316. For example, the training data 310 may include a real-world survey of a plurality of marketing emails sent to different audience segments with different performance objectives. The training data 310 may be processed to feed the different types of data (e.g., content, audience segments, and performance results) through different training paths of the performance training module 130 (see, for example, FIG. 3). In various embodiments, during an inference phase, the input data 310 may be from a prompt and the different categories 312, 314, and 316 may be extracted from the prompt and provided to the AI/ML architecture 300 components.

As shown in FIG. 3, the segments data 312 is provided to a segment encoding model 302 operative to transform the segments data 312 into segment encodings 320. In some embodiments, the segment encoding model 302 is an NLP model, a language model, and/or an LLM. Non-limiting examples of AI/ML models for the segment encoding model 302 include transformers, Bidirectional Encoder Representations from Transformers (BERT) models, A Lite BERT (ALBERT) (such as Albert base v2) models, and/or the like. In various embodiments, the segment encodings 320 represent the content of segments data 312 (e.g., text and/or other content elements) in a numerical form. In some embodiments, the segment encodings 320 are provided to a segments encodings network 330 and transformed into segment encodings 340. In various embodiments, the segments encodings network 330 is or includes an AI/ML network, such as a neural network, perceptron, and/or the like. In some embodiments, the segments encodings network 330 is an MLP.

Similarly, the content data 316 is provided to a content encoding model 304 operative to transform the content data 316 into content encodings 324. In some embodiments, the content encodings 324 are provided to a content encodings network 334 (e.g., an MLP or similar AI/ML model) configured to generate content encodings 344. In various embodiments, the performance data 314 is provided to a performance data network 332 and transformed into performance encodings 342.

The segment encodings 340, the performance encodings 342, and the content encodings 344 are provided to an aggregation model 350 operative to aggregate, attenuate, concatenate, attention, or otherwise combine the encodings 340, 342, and 344 into an encodings aggregate 362. In some embodiments, the aggregation model 350 is or includes an attention model configured to aggregate the encodings 340, 342, and 344 via attention processing and/or attention-masking processing. In various embodiments, the aggregation model 350 utilizes concatenation or attention with pooling to combine the intermediate features of the encoded input data from different sources and modalities before computing the logits which will ultimately become the performance prediction 350 (i.e., reflecting the performance of the content-customer pair for a certain performance objective, such as clicking/not clicking on a link in the content).

The encodings aggregate 362 is provided to the performance prediction model 250 to generate a performance prediction 352. In some embodiments, the performance prediction model 250 is or includes an AI/ML network, such as a neural network, an artificial neural network, and/or the like. In various embodiments, the performance prediction model 250 is a feedforward artificial neural network, a perceptron, an MLP, and/or the like.

In various embodiments, the performance prediction 352 is a value indicating the likelihood, probability, and/or the like that a content recipient will perform a desired action, such as a defined performance objective or KPI. In some embodiments, the performance prediction 352 is a score or other numerical value, for instance, indicating the probability that a content recipient will perform the desired action (e.g., on a scale of 0.0 to 1.0 (or 0 to 100), with 0.0 indicating a low or no probability and 1.0 indicating a high probability). In various embodiments, the performance prediction 352 is a binary (e.g., 0 or 1, “yes” or “no,” and/or the like) value indicating whether a recipient will perform the desired action. The performance prediction 352 is a value representing the predicted likelihood of performance of the content-customer pair for a certain performance objective, such as a defined KPI. For example, a performance prediction 352 of 0.5 for input data 310 of a marketing email (or a prompt to create the marketing email campaign) for a specific KPI for an audience segment indicates that there is a 50% chance that a recipient within the audience segment will perform the KPI (e.g., clicking on a link).

FIG. 4 illustrates an example of a processing flow in accordance with embodiments described in the present disclosure. More specifically, FIG. 4 illustrates an example of a processing flow 400 for training and/or tuning a content generation model 140. As shown in FIG. 4, model training module 122 includes a content generation training module 132 configured to access a performance prediction model 250, content generation prompts 410, and a base content generation model 420.

The performance prediction model 250 is an AI/ML model as configured and trained according to some embodiments, for example, as depicted in FIGS. 2 and 3.

In some embodiments, the base content generation model 420 is an AI/ML model trained to generate content based on user prompts. In various embodiments, the base content generation model 420 is a language model, an LLM, a NLP, and/or the like. A non-limiting example of the base content generation model 420 is the LLaMA model and/or variations thereof. In some embodiments, the base content generation model 420 is trained and/or tuned via an optimization process, such as an instruction optimization process. In various embodiments, the base content generation model 420 is an instruct-optimized generative language model (e.g., LLaMA2). In exemplary embodiments, the base content generation model 420 includes about 7 billion parameters and/or is quantized to 4-bits.

In some embodiments, the performance prediction model 250, content generation prompts 410, and a base content generation model 420 are used by the content generation training module 132 to perform an RL training process to train and/or tune the content generation model 140 to generate content for a targeted audience with the aim of prompting one or more specified performance objectives.

FIG. 5 illustrates an example of a processing flow in accordance with embodiments described in the present disclosure. More specifically, FIG. 5 illustrates an example of a processing flow 500 for RL training and/or tuning of the content generation model 140, for example, performed via the content generation training module 132.

Non-limiting examples of RL processes include Deep Q-Learning (DQL), Vanilla Policy Gradient Algorithm (VPG), Trust Region Policy Optimization (TRPO), proximal policy optimization (PPO), reinforcement learning from human feedback (RLHF), and/or the like. In some embodiments, the processing flow 500 uses a policy gradient method for RL. In various embodiments, the processing flow 500 uses a PPO training/tuning process. A non-limiting example of PPO includes the OpenAI® PPO. Another non-limiting example of PPO includes the process described in Schulman et al., “Proximal Policy Optimization Algorithms,” arXiv.org, https://arxiv.org/abs/1707.06347, arXiv: 1707.06347 (2017).

Although PPO is used in some examples, embodiments are not so limited. For example, various types of RL processes can be used, for instance, RL processes or algorithms that use the output (e.g., the logits or the processed logits, such as SoftMax-processed logits) of the performance prediction model 250 and account for divergence from a base model.

The content generation model 140 and a base content generation model 420 receive input in the form of an input prompt 410. In some embodiments, at the start of training, the content generation model 140 is the same or substantially the same as the base content generation model 420 (e.g., instruction trained). During training, the content generation model 140 diverges from the base content generation model 420 via the RL of processing flow 500. In various embodiments, the content generation model 140 is tuned using various tuning processes, including, without limitation Low-Rank Adaptation (LoRA) (e.g., with about 8 million trainable parameters).

FIGS. 6A and 6B illustrate features of the subject matter in accordance with embodiments described in the present disclosure. More specifically, FIGS. 6A and 6B depict illustrative input prompts according to some embodiments.

Referring to FIG. 6A, a content generation prompt 410 includes content generation information in the form of various definitions or elements for generating content. The content generation prompt 410 includes information for the intent of the content, such as the content's objectives and content elements (e.g., text, graphics, etc.). In general, the content generation prompt 410 defines one or more target audiences (segment definition 602), a subject for the content (subject definition 604), and a desired performance objective (performance definition 606). The segment definition 602 can include information describing one or more audience personas or segments to be targeted by the content. For example, the segment definition can include text indicating that the target audience are programming professionals aged 25 to 35 that have experience with Product A. The subject definition 604 can include information associated with the subject and/or form of the content. Examples of a subject are a product, a service, a website, and/or the like. For example, the subject definition 604 can be the name of a product or service or a link to a website for a product or service. In another example, the subject definition 604 can be a text description of a product or service. Examples of the form of the content can include instructions defining how the content is to be delivered, such as email, text, video, website, and/or the like. The performance definition 606 indicates the desired performance objectives or KPIs for the content, such as reading/viewing the content, clicking a link in the content, an interaction duration goal, test score goal, and/or the like. A content generation prompt 410 can include additional elements, such as a style definition 608 and generation instructions 610. The style definition 608 indicates any stylistic characteristics, such as persuasiveness, corporate guidelines, preferred terms, prohibited terms, colors, content look-and-feel, and/or the like. The generation instructions 610 indicate any other information relevant to generating the content that does not fall into one of the other categories. For example, the intent of the content, campaign, and/or the like (for instance, to educate, drive engagement, informative, awareness, and/or the like). The generation instructions 610 can also include text length, character limits, token limits, use/non-use of emojis or other symbols, and/or the like. In some embodiments, the generation instructions 610 include directions for creating text or other content items (for example, “provide a response that matches the user's information and intended ad campaign, including the recommended tone, language, and focus on education and creativity. Use the given article and URL as the basis for the response, and adjust the content as necessary”).

In various embodiments, the input prompt 410 includes content (with a first performance prediction 352) and the generated content 550 comprises reformulated content with a second performance prediction 352 (i.e., higher than the first performance prediction). Accordingly, in some embodiments, the content generation model 140 receives content as the input prompt 410 (e.g., for a specific audience, subject, etc.) and generates updated content 550 which has an improved performance prediction 352.

In one non-limiting example, the input prompt 410 includes the following first content: “Campaign Name: Graphics Editor—Quick Actions; Article Name: Boost Your Photo Editing Speed with Graphics Editor's New Quick Actions; Headline: Streamline Your Photo Editing with these 20 Time-Saving Tips; Description: Discover Graphics Editor's latest time-saving features and get the inside scoop on 20 of the fastest and most powerful Quick Actions. From background removal to skin smoothing, these tips will help you streamline your photo editing process; URL: <Graphics Editor—Quick Actions URL>; Call to Action: Don't miss out! Try Graphics Editor's Quick Actions now; Email Subject Line: Turbocharge your photo editing with Graphics Editor's new Quick Actions; Preheader: Get the inside scoop on these 20 time-saving tips for photo editing.” The content generation model 140 generates the following second content 550 with a greater performance prediction 352 value than the first content: “Campaign Name: Graphics Editor Quick Actions; Article Name: Master the Fast Way to Edit Photos with Graphics Editor Quick Actions; Headline: Love Your Photos Faster with Graphics Editor Quick Actions; Description: Get instant creative control with Graphics Editor Quick Actions. Learn how to remove a background, smooth skin, and more in just one click; URL: <Graphics Editor—Quick Actions URL>; Call to Action: Try Graphics Editor Quick Actions today!; Email Subject Line: Unlock the Secrets of Fast and Easy Photo Editing with Graphics Editor Quick Actions; Preheader: Give Your Photos a Makeover with the Power of Graphics Editor Quick Actions.”

Referring to FIG. 6B, therein is depicted a non-limiting example of a content generation prompt 410, defining the type of content, the form of the content, required elements, and stylistic instructions. As indicated in FIG. 6B, a content generation prompt 410 can be or can include natural language text. However, a content generation prompt 410 does not require a full textual description, for instance, a content generation prompt 410 can include other forms of information and/or levels of description. For example, a content generation prompt 410 can include a link to a product website, a list of target audiences, and a performance objective. The content generation module 132 includes logic, software, instructions, AI/ML models, and/or the like to search, process, evaluate, or otherwise determine information based on information provided in a content generation prompt 410.

Returning to FIG. 5, the content generation prompt 410 is provided to the base content generation model 420 that generates base content 560. The content generation model 140 receives the same content generation prompts and generates content 550 (i.e., content intended for distribution).

The base content 560 and the content 550 are provided to a divergence module 510 to determine a divergence between the content generated by the base content generation model 420 and the content generation model 140. In general, the divergence module 510 is configured to ensure that the content generation model 140 is generating quality, coherent content and is not, alternatively, generating unusable, unintelligible content that is, nonetheless, scoring high via the performance prediction model 250. In some embodiments, the divergence module 510 is or includes a Kullback-Leibler (KL) divergence, such as a KL-prediction shift penalty. In general, a KL divergence is a statistical process for determining the difference in two distributions (for instance, a non-symmetric metric that measures the relative entropy or difference in information represented by two distributions). The KL-prediction shift penalty of the divergence module 510 provides an indication of the divergence between the base content 550 and the content 560.

The content 560 from the content generation model 140 is also provided to the performance prediction model 250 to determine a performance prediction 352 for the content 450. In the RL process, the shift penalty from the divergence module 510 is summed 530 with the performance prediction 352 for an RL update function 520 used to train and/or tune the content generation model 140.

In general, the RL process defines a policy π configured as a function that returns a feasible action y given a state x. In policy-based methods, the function (e.g., a neural network) is defined by a set of tunable parameters θ. The parameters can be adjusted (e.g., via the RL update function 520), the differences in the resulting rewards (e.g., the performance prediction 352) can be determined/observed, and the parameters θ can be updated in a direction that returns higher regards (a greater performance prediction 352 for the content 560).

Therefore, the processing flow 500 for RL training according to some embodiments trains/tunes the content generation model 140 to generate content 550 that optimizes for the reward of a higher performance prediction 352 while including content elements (e.g., text, etc.) that remain coherent and intelligible because they are constrained by having a limited divergence from base content. Content 550 generated by the trained and tuned content generation model 140 is associated with higher performance prediction 352 values than content created using other AI/ML models (including similar models not tuned/trained according to some embodiments). Accordingly, the content generation model 140 is able to generate content that is more effective at eliciting a desired response (i.e., a KPI) than content generated by conventional text generation models, including GPT-3.5, GPT-4, Bard, Bing, Claude, Typeface, EmailDojo, CopyAI, and/or the like.

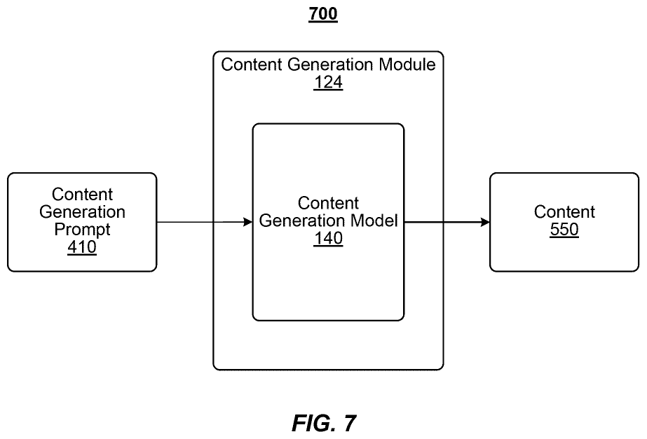

FIG. 7 illustrates an example of a processing flow in accordance with embodiments described in the present disclosure. More specifically, FIG. 7 depicts a processing flow 700 for generating content 550 from a content generation prompt 410. As shown in FIG. 7, the content generation module 124 uses a trained content generation model 140. During inference, the content generation model 140 receives a content generation prompt 410 (see, for example, FIGS. 6A and 6B) and generates the content 550. The form and substance of the content is optimized to achieve a performance objective, to target an audience segment, and to include content elements (e.g., text, subject, header, body, graphics, etc.) specified in the content generation prompt 410.

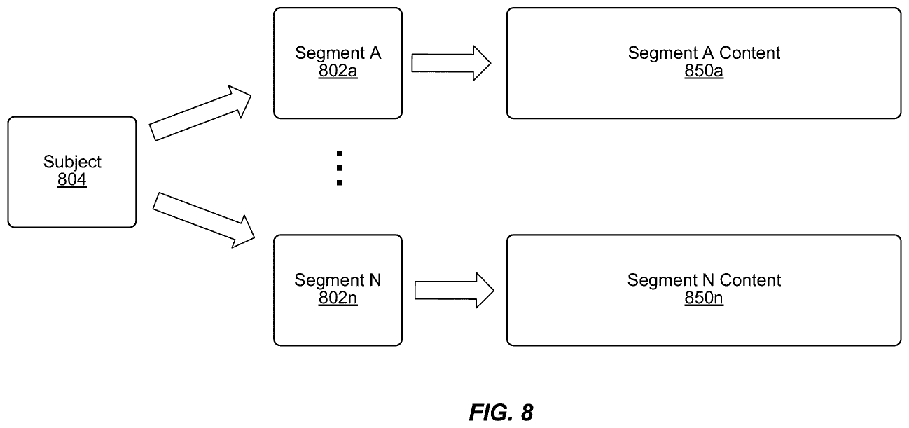

FIG. 8 illustrates features of the subject matter in accordance with embodiments described in the present disclosure. More specifically, FIG. 8 illustrates the generation of different content 850a-n for different audience segments 802a-n for the same subject 804. In one example, a user prompt describes a subject 804, such as an automobile for an advertising campaign, two demographics (Segment A 802a and Segment N 802n) to be targeted by the advertising campaign, and a KPI of visiting an automobile dealer website. The content generation model 140 inferences to generate two different content offerings, for example, Segment A Content 850a targeted for Segment A 802a and Segment N Content 850n targeted for Segment N 802n. Content 850a and 850n may include different text, graphics, calls to action, or other elements determined to be optimized for eliciting the requested performance objective KPI.

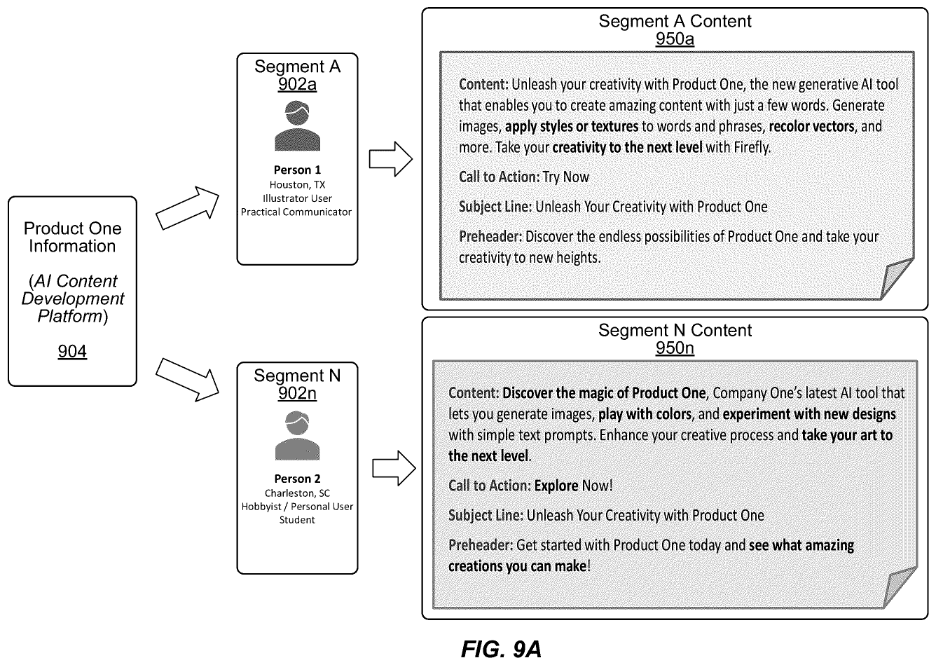

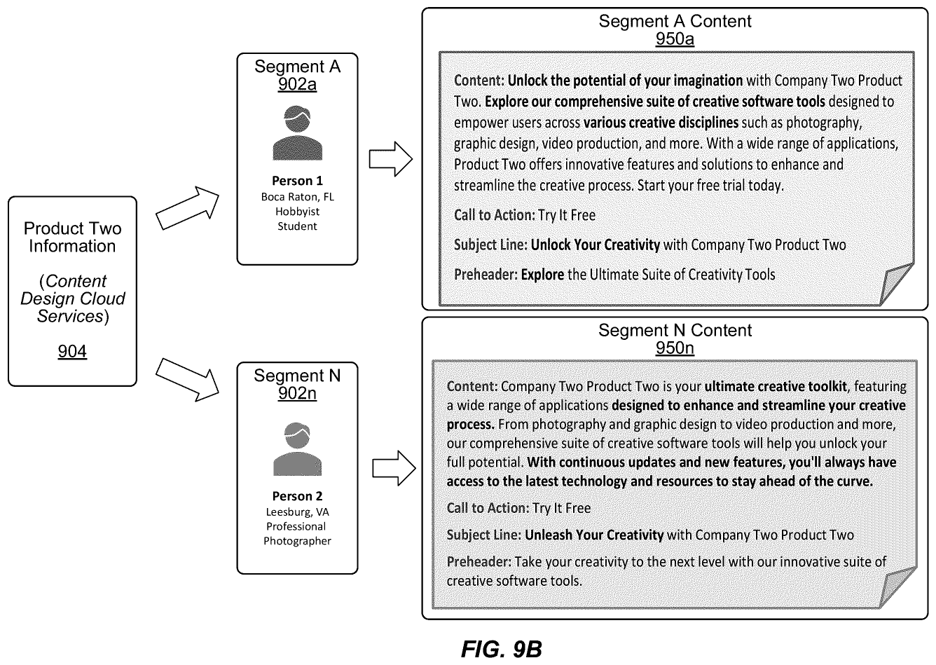

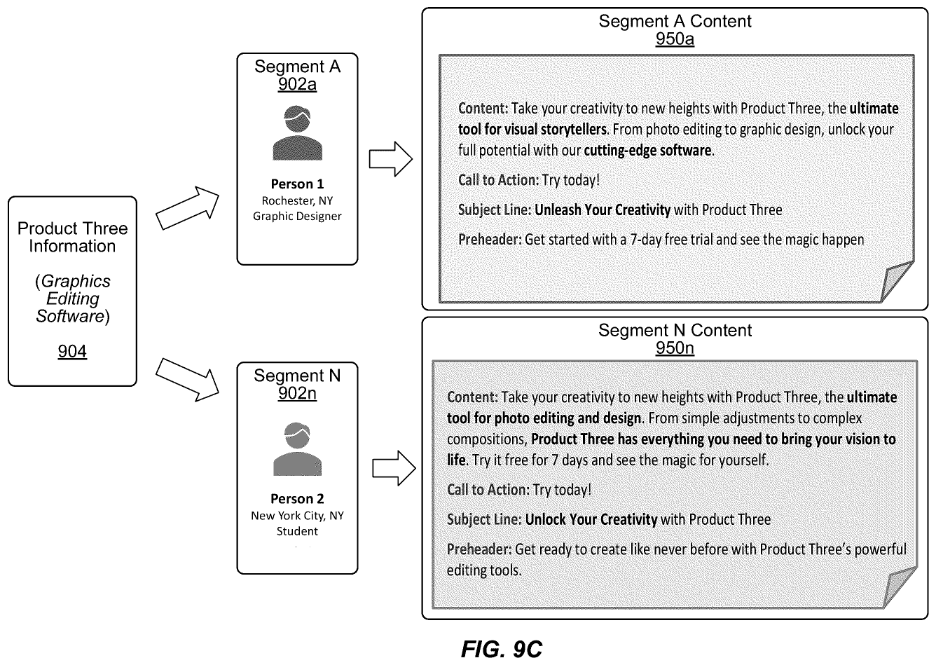

FIGS. 9A-9C illustrate features of the subject matter in accordance with embodiments described in the present disclosure. More specifically, FIGS. 9A-9C depict content generated using the content generation model 140 configured, trained, and tuned according to some embodiments.

Referring to FIG. 9A, the subject 904 is an AI content development platform “Product One” (e.g., Adobe® Firefly™) specified in a user prompt by a URL for the platform. A first target segment is Segment A 902a that includes experienced or professional users of the platform (typified by example Person 1). The targeted content 950a for Segment A 902a is a generated email that accentuates the features of Product One tailored to the expertise of Segment A 902a members, such as advanced styles and textures, and artfully highlights how Product One can elevate their vector designs through effortless recoloring.

A second target segment is Segment N 902n that includes novice users, students, hobbyists, and/or the like (typified by example Person 2). The targeted content 950n for Segment A 902n is an email that appeals to the curiosity of Segment N 902n members, nudging them to uncover the enchantment of Product One and urges them to embark on a journey of creative exploration, experimenting with colors and new designs.

FIG. 9B depicts an example for Product Two, content design cloud services (e.g., Adobe® Creative Cloud®). FIG. 9C depicts and example for Product Three, graphics editing software (e.g., Adobe® Photshop®). As depicted in FIGS. 9A-9C, the content 950a, 950n for different audience segments 904a, 904n can include different content elements, even for the same subject, such as a title or subject line, body text, calls to action, pre-headers, offers, language styles, and/or the like.

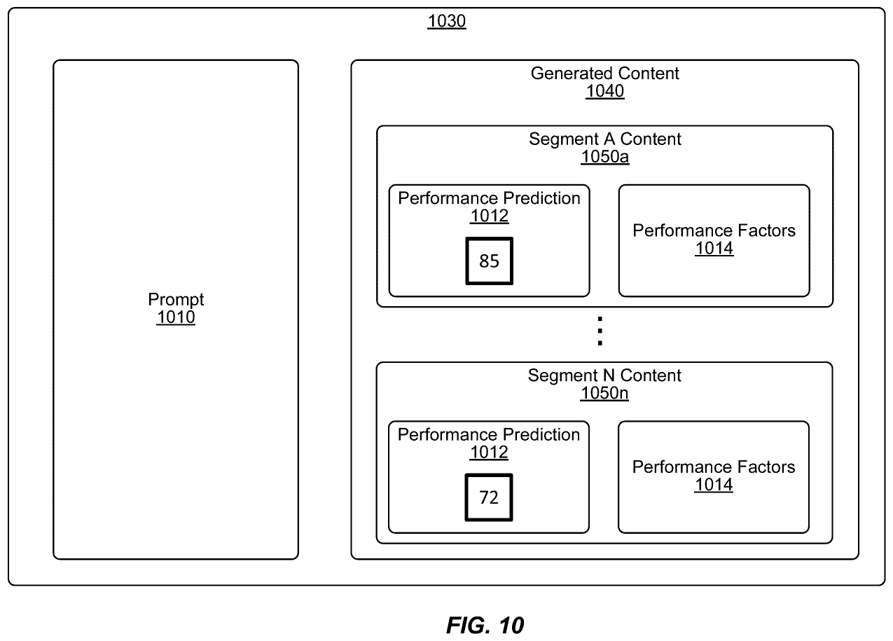

FIG. 10 illustrates features of the subject matter in accordance with embodiments described in the present disclosure. More specifically, FIG. 10 depicts a graphical user interface (GUI) 1030 for a user to interact with the content generation system 110 to generate content. In some embodiments, the GUI 1030 is implemented via application 103 accessed by a user through user device 102.

As shown in FIG. 10, a user can upload, enter, select (e.g., based on selection options), or otherwise provide a prompt 1010 (see, for example, FIGS. 6A and 6B). Responsive to entering the prompts 1010, the GUI 1030 displays generated content 1050a-n. In some embodiments, the content 1050a-n includes multiple content designs for different audience segments and/or multiple options for the same audience segment. In various embodiments, the content 1050a-n may include various metrics, such as a performance prediction value 1012 and/or performance factors 1014. Accordingly, a user can select among the different content 1050a-n based on the score and/or the content elements. For example, a first content item 1050a may have a higher performance prediction 1012 than a second content item 1050n; however, the user prefers the second content item 1050n (for instance, it more closely follows corporate guidelines for marketing materials, better corresponds with existing marketing, and/or the like). The performance factors 1014 allow a user to visualize the different factors that effected the performance prediction (e.g., increased/decreased the performance prediction), for example, using a logo, offer language, graphics, format, publication source (e.g., email versus YouTube® video), and/or the like.

Operations for the disclosed embodiments are further described with reference to the following figures. Some of the figures include a logic flow. Although such figures presented herein include a particular logic flow, the logic flow merely provides an example of how the general functionality as described herein is implemented. Further, a given logic flow does not necessarily have to be executed in the order presented unless otherwise indicated. Moreover, not all acts illustrated in a logic flow are required in some embodiments. In addition, the given logic flow is implemented by a hardware element, a software element executed by one or more processing devices, or any combination thereof. The embodiments are not limited in this context.

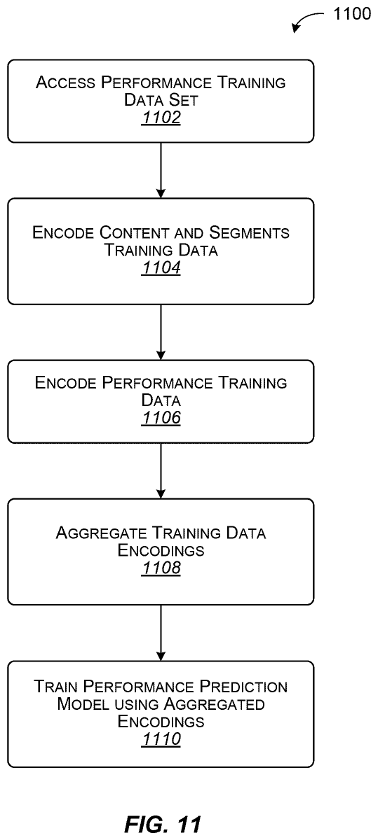

FIG. 11 illustrates an embodiment of a logic flow 1100. The logic flow 1100 is representative of some or all of the operations executed by one or more embodiments described herein, for example, for training a model to predict the effectiveness of performance objectives for content for different audience segments. For example, the logic flow 1100 includes some or all of the operations performed by devices or entities within the system 110, system 1400 or the apparatus 1500.

In one embodiment, the logic flow 1100 is implemented as instructions stored on a non-transitory computer-readable storage medium, such as the storage medium 1422, that when executed by the processing circuitry 1418 causes the processing circuitry 1418 to perform the described operations. The storage medium 1422 and processing circuitry 1418 may be co-located, or the instructions may be stored remotely from the processing circuitry 1418. Collectively, the storage medium 1422 and the processing circuitry 1418 may form a system.

In block 1102, the logic flow 1100 includes accessing a performance training data set. For example, training data 210 that includes segments 212, performance 214, and content 216 training data is provided to the performance training module 130.

The logic flow 1100 includes encoding content training data and segments training data at block 1104. For example, each of the segments 212 and content 216 training data follows a separate encoding path. In reference to FIG. 3, the segments 212 training data is encoded by a segment encoding model 302 and/or a segment encodings network 330 to generate segment encodings 340. The content 216 training data is encoded by a content encoding model 304 and/or a content encodings network 334 to generate content encodings 344.

In block 1106, the logic flow 1100 includes encoding performance training data. For example, historical performance 214 training data (e.g., KPI results information associated with the segments 212 and content 216 training data) is provided to a performance data network 332 to generate performance encodings 342.

The logic flow 1100 includes aggregating training data encodings at block 1108. For example, an aggregation module 350 concatenates, attenuates, masks, and/or otherwise aggregates the segment encodings 340, performance encodings 342, and content encodings 344 to generate an encodings aggregate 362.

In block 1110, the logic flow 1100 includes training the performance prediction model using the aggregated encodings. For example, the encodings aggregate 362 is provided to a performance prediction model 250, such as an NN, ANN, MLP, and/or the like to train the performance prediction model 250 to generate a performance prediction 352. In some embodiments, the performance prediction model 250 operates to simulate the performance of content for an audience segment, as indicated by the performance prediction 352 (i.e., a probability that the content will elicit the desired performance objective for the audience segment).

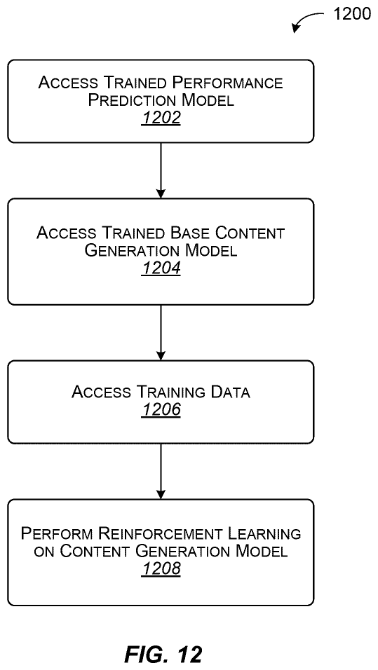

FIG. 12 illustrates an embodiment of a logic flow 1200. The logic flow 1200 is representative of some or all of the operations executed by one or more embodiments described herein, for example, for training a model to generate content for different audience segments based on a performance objective. For example, the logic flow 1200 includes some or all of the operations performed by devices or entities within the system 110, system 1400 or the apparatus 1500.

In one embodiment, the logic flow 1200 is implemented as instructions stored on a non-transitory computer-readable storage medium, such as the storage medium 1422, that when executed by the processing circuitry 1418 causes the processing circuitry 1418 to perform the described operations. The storage medium 1422 and processing circuitry 1418 may be co-located, or the instructions may be stored remotely from the processing circuitry 1418. Collectively, the storage medium 1422 and the processing circuitry 1418 may form a system.

In block 1202, the logic flow 1200 includes accessing a trained performance prediction model. For example, the trained performance prediction model 250 trained according to FIGS. 2, 3, and 11 is accessed by the content generation module 132. The logic flow 1200 includes accessing a trained base content generation model at block 1204. For example, a base, instruction-trained LLM is provided to the content generation module 132. In block 1206, the logic flow 1200 includes accessing training data. For example, user prompt 410 training data is provided to the content generation module 132.

The logic flow 1200 includes performing reinforcement learning on a content generation model at block 1208. For example, a content generation model 140 is trained using an RL process, such as a policy gradient method, such as PPO. The RL process use the output (e.g., the logits or the processed logits, such as SoftMax-processed logits) of the performance prediction model 250 and account for divergence from a base model 420 via a divergence module 510. In this manner, the content generation model 140 is trained to generate content that is configured to elicit a performance objective from recipients, while not diverging drastically from a base content configuration, for instance, as defined in a trained base model 420.

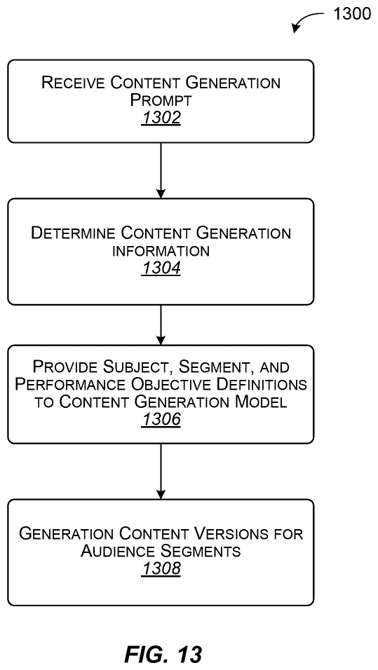

FIG. 13 illustrates an embodiment of a logic flow 1300. The logic flow 1300 is representative of some or all of the operations executed by one or more embodiments described herein, for example, generating content for different audience segments based on a performance objective using an AI/ML model. For example, the logic flow 1300 includes some or all of the operations performed by devices or entities within the system 110, system 1400 or the apparatus 1500.

In one embodiment, the logic flow 1300 is implemented as instructions stored on a non-transitory computer-readable storage medium, such as the storage medium 1422, that when executed by the processing circuitry 1418 causes the processing circuitry 1418 to perform the described operations. The storage medium 1422 and processing circuitry 1418 may be co-located, or the instructions may be stored remotely from the processing circuitry 1418. Collectively, the storage medium 1422 and the processing circuitry 1418 may form a system.

In block 1302, the logic flow 1300 includes receiving a content generation prompt. For example, a prompt 410 (see, for instance, FIGS. 6A and 6B) is provided to a content generation model 140 of the content generation module 124.

The logic flow 1300 includes determining content generation information at block 1304. For example, a subject (e.g., a product), audience segments (e.g., professionals aged 35-45 years old, novices aged 18-55 years old, and/or the like), and performance objectives (e.g., opening an email, clicking on a link, and/or the like) are determined from the prompt 410.

In block 1306, the logic flow 1300 includes providing subject, segment, and performance objective definitions to a trained content generation model. For instance, the content generation information extracted from the prompt 410, such as the subject, segment, and performance information that forms the intended target and goals of the resulting content, are provided to the content generation model 140. In some embodiments, the content generation information from the prompt 410 is also provided to a base model 420.

The logic flow 1300 includes at block 1308 generating content versions for audience segments. For example, the content generation model 140 generates different forms of content 550 (e.g., content 850a-n or content 950a-n) for different audience segments. In various embodiments, the base model 420 generates base content 560 for a divergence process with content 550 for a reinforcement learning/tuning process. Referring to FIG. 5, in some embodiments, the content is provided to the performance prediction model 250 to generate a performance prediction 352. If the performance prediction 352 value is below a performance threshold (e.g., below 50%, below 70%, below 80%, or another value or range), the content generation model 140 performs another iteration of content generation to create content 550 that meets the threshold requirements for the performance prediction. In various embodiments, the content 550 is displayed on a GUI 1030 to an operator along with performance information, such as a performance prediction value 1012 and/or performance factors 1014.

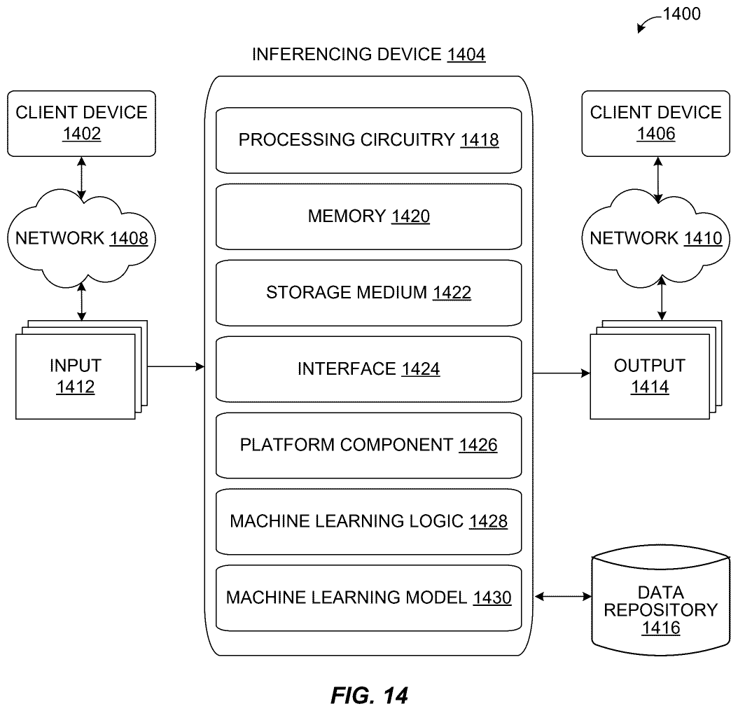

FIG. 14 illustrates an embodiment of a system 1400. The system 1400 is suitable for implementing one or more embodiments as described herein. In one embodiment, for example, the system 1400 is an AI/ML system suitable for generating audience-targeted content.

The system 1400 comprises a set of M devices, where M is any positive integer. FIG. 14 depicts three devices (M=3), including a client device 1402, an content creation device 1404, and a client device 1406. The content creation device 1404 communicates information with the client device 1402 and the client device 1406 over a network 1408 and a network 1410, respectively. The information includes input 1412 from the client device 1402 and output 1414 to the client device 1406, or vice-versa. In one alternative, the input 1412 and the output 1414 are communicated between the same client device 1402 or client device 1406. In another alternative, the input 1412 and the output 1414 are stored in a data repository 1416. In yet another alternative, the input 1412 and the output 1414 are communicated via a platform component 1426 of the content creation device 1404, such as an input/output (I/O) device (e.g., a touchscreen, a microphone, a speaker, etc.).

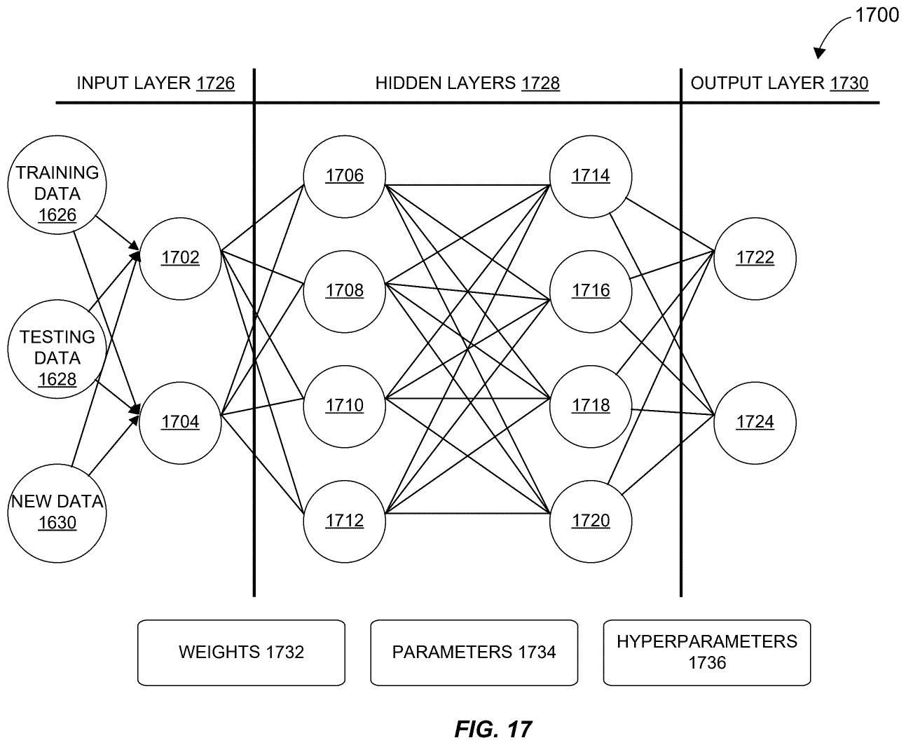

As depicted in FIG. 14, the content creation device 1404 includes processing circuitry 1418, a memory 1420, a storage medium 1422, an interface 1424, a platform component 1426, ML logic 1428, and an ML model 1430. In some implementations, the content creation device 1404 includes other components or devices as well. Examples for software elements and hardware elements of the content creation device 1404 are described in more detail with reference to a computing architecture 1700 as depicted in FIG. 17. Embodiments are not limited to these examples.

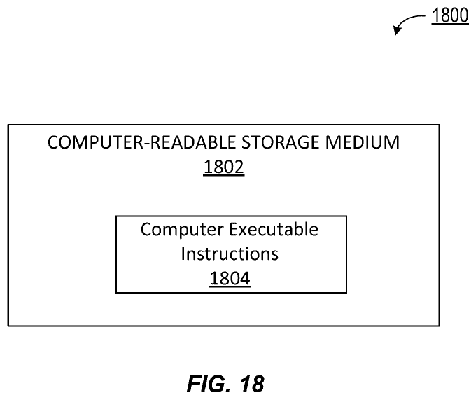

The content creation device 1404 is generally arranged to receive an input 1412, process the input 1412 via one or more AI/ML techniques, and send an output 1414. In one example, the input 1412 is digital visual content, such as a video or image. The content creation device 1404 receives the input 1412 from the client device 1402 via the network 1408, the client device 1406 via the network 1410, the platform component 1426 (e.g., a touchscreen as a text command or microphone as a voice command), the memory 1420, the storage medium 1422 or the data repository 1416. The content creation device 1404 sends the output 1414 to the client device 1402 via the network 1408, the client device 1406 via the network 1410, the platform component 1426 (e.g., a touchscreen to present text, graphic or video information or speaker to reproduce audio information), the memory 1420, the storage medium 1422 or the data repository 1416. The output 1414 includes one or more recommendation style elements. Examples for the software elements and hardware elements of the network 1408 and the network 1410 are described in more detail with reference to a communications architecture 1800 as depicted in FIG. 18. Embodiments are not limited to these examples.

The content creation device 1404 includes ML logic 1428 and an ML model 1430 to implement various AI/ML techniques for various AI/ML tasks. The ML logic 1428 receives the input 1412, and processes the input 1412 using the ML model 1430, e.g., identifies style element candidates that can be implemented in a design. The ML model 1430 performs inferencing operations to generate an inference for a specific task from the input 1412. In some cases, the inference is part of the output 1414. The output 1414 is used by the client device 1402, the content creation device 1404, or the client device 1406 to perform subsequent actions in response to the output 1414.

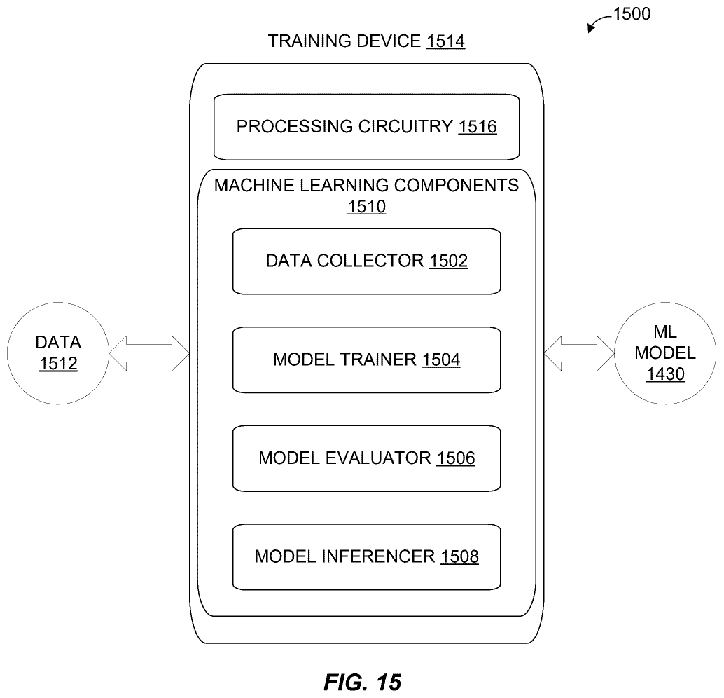

In various embodiments, the ML model 1430 is a trained ML model 1430 using a set of training operations. An example of training operations to train the ML model 1430 is described with reference to FIG. 15.

FIG. 15 illustrates an apparatus 1500. The apparatus 1500 depicts a training device 1514 suitable to generate a trained ML model 1430 for the content creation device 1404 of the system 1200. As depicted in FIG. 15, the training device 1514 includes a processing circuitry 1516 and a set of ML components 1510 to support various AI/ML techniques, such as a data collector 1502, a model trainer 1504, a model evaluator 1506 and a model inferencer 1508. In one example, the training device 1514 performs the training operations, as discussed in FIG. 1 and/or FIG. 3.

In general, the data collector 1502 collects data 1512 from one or more data sources to use as training data for the ML model 1230. The data collector 1502 collects different types of data 1512, such as text information, audio information, image information, video information, graphic information, and so forth. The model trainer 1504 receives as input the collected data and uses a portion of the collected data as test data for an AI/ML algorithm to train the ML model 1230. The model evaluator 1506 evaluates and improves the trained ML model 1230 using a portion of the collected data as test data to test the ML model 1230. The model evaluator 1506 also uses feedback information from the deployed ML model 1230. The model inferencer 1508 implements the trained ML model 1230 to receive as input new unseen data, generate one or more inferences on the new data, and output a result such as an alert, a recommendation or other post-solution activity.

An exemplary AI/ML architecture for the ML components 1510 is described in more detail with reference to FIG. 14.

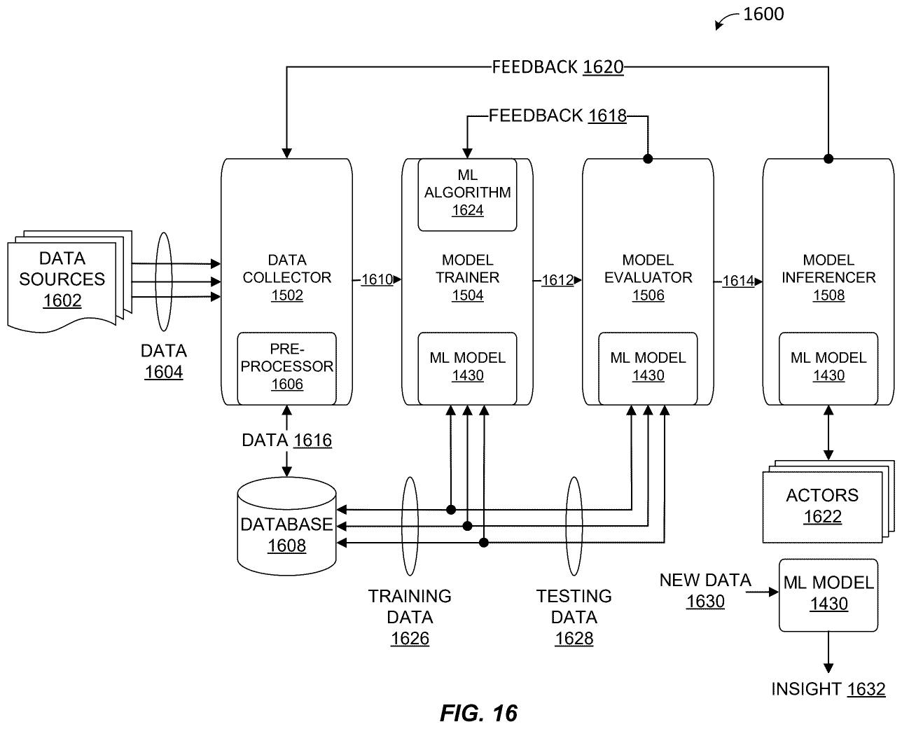

FIG. 16 illustrates an artificial intelligence architecture 1600 suitable for use by the training device 1514 to generate the ML model 1430 for deployment by the content creation device 1404. The artificial intelligence architecture 1600 is an example of a system suitable for implementing various AI techniques and/or ML techniques to perform various inferencing tasks on behalf of the various devices of the system 1400.

AI is a science and technology based on principles of cognitive science, computer science and other related disciplines, which deals with the creation of intelligent machines that work and react like humans. AI is used to develop systems that can perform tasks that require human intelligence such as recognizing speech, vision and making decisions. AI can be seen as the ability for a machine or computer to think and learn, rather than just following instructions. ML is a subset of AI that uses algorithms to enable machines to learn from existing data and generate insights or predictions from that data. ML algorithms are used to optimize machine performance in various tasks such as classifying, clustering and forecasting. ML algorithms are used to create ML models that can accurately predict outcomes.

In general, the artificial intelligence architecture 1600 includes various machine or computer components (e.g., circuit, processor circuit, memory, network interfaces, compute platforms, input/output (I/O) devices, etc.) for an AI/ML system that are designed to work together to create a pipeline that can take in raw data, process it, train an ML model 1430, evaluate performance of the trained ML model 1430, and deploy the tested ML model 1430 as the trained ML model 1430 in a production environment, and continuously monitor and maintain it.

The ML model 1430 is a mathematical construct used to predict outcomes based on a set of input data. The ML model 1430 is trained using large volumes of training data 1626, and it can recognize patterns and trends in the training data 1626 to make accurate predictions. The ML model 1430 is derived from an ML algorithm 1624 (e.g., a neural network, decision tree, support vector machine, etc.). A data set is fed into the ML algorithm 1624 which trains an ML model 1430 to “learn” a function that produces mappings between a set of inputs and a set of outputs with a reasonably high accuracy. Given a sufficiently large enough set of inputs and outputs, the ML algorithm 1624 finds the function for a given task. This function can produce the correct output for input that it has not seen during training. A data scientist prepares the mappings, selects and tunes the ML algorithm 1624, and evaluates the resulting model performance. Once the ML logic 1428 is sufficiently accurate on test data, it can be deployed for production use.

The ML algorithm 1624 includes any ML algorithm suitable for a given AI task. Examples of ML algorithms includes supervised algorithms, unsupervised algorithms, or semi-supervised algorithms.

A supervised algorithm is a type of machine learning algorithm that uses labeled data to train a machine learning model. In supervised learning, the machine learning algorithm is given a set of input data and corresponding output data, which are used to train the model to make predictions or classifications. The input data is also known as the features, and the output data is known as the target or label. The goal of a supervised algorithm is to learn the relationship between the input features and the target labels, so that it can make accurate predictions or classifications for new, unseen data. Examples of supervised learning algorithms include: (1) linear regression which is a regression algorithm used to predict continuous numeric values, such as stock prices or temperature; (2) logistic regression which is a classification algorithm used to predict binary outcomes, such as whether a customer will purchase or not purchase a product; (3) decision tree which is a classification algorithm used to predict categorical outcomes by creating a decision tree based on the input features; or (4) random forest which is an ensemble algorithm that combines multiple decision trees to make more accurate predictions.

An unsupervised algorithm is a type of machine learning algorithm that is used to find patterns and relationships in a dataset without the need for labeled data. Unlike supervised learning, where the algorithm is provided with labeled training data and learns to make predictions based on that data, unsupervised learning works with unlabeled data and seeks to identify underlying structures or patterns. Unsupervised learning algorithms use a variety of techniques to discover patterns in the data, such as clustering, anomaly detection, and dimensionality reduction. Clustering algorithms group similar data points together, while anomaly detection algorithms identify unusual or unexpected data points. Dimensionality reduction algorithms are used to reduce the number of features in a dataset, making it easier to analyze and visualize. Unsupervised learning has many applications, such as in data mining, pattern recognition, and recommendation systems. It is particularly useful for tasks where labeled data is scarce or difficult to obtain, and where the goal is to gain insights and understanding from the data itself rather than to make predictions based on it.

Semi-supervised learning is a type of machine learning algorithm that combines both labeled and unlabeled data to improve the accuracy of predictions or classifications. In this approach, the algorithm is trained on a small amount of labeled data and a much larger amount of unlabeled data. The main idea behind semi-supervised learning is that labeled data is often scarce and expensive to obtain, whereas unlabeled data is abundant and easy to collect. By leveraging both types of data, semi-supervised learning can achieve higher accuracy and better generalization than either supervised or unsupervised learning alone. In semi-supervised learning, the algorithm first uses the labeled data to learn the underlying structure of the problem. It then uses this knowledge to identify patterns and relationships in the unlabeled data, and to make predictions or classifications based on these patterns. Semi-supervised learning has many applications, such as in speech recognition, natural language processing, and computer vision. It is particularly useful for tasks where labeled data is expensive or time-consuming to obtain, and where the goal is to improve the accuracy of predictions or classifications by leveraging large amounts of unlabeled data.

The ML algorithm 1624 of the artificial intelligence architecture 1600 is implemented using various types of ML algorithms including supervised algorithms, unsupervised algorithms, semi-supervised algorithms, or a combination thereof. A few examples of ML algorithms include support vector machine (SVM), random forests, naive Bayes, K-means clustering, neural networks, and so forth. A SVM is an algorithm that can be used for both classification and regression problems. It works by finding an optimal hyperplane that maximizes the margin between the two classes. Random forests is a type of decision tree algorithm that is used to make predictions based on a set of randomly selected features. Naive Bayes is a probabilistic classifier that makes predictions based on the probability of certain events occurring. K-Means Clustering is an unsupervised learning algorithm that groups data points into clusters. Neural networks is a type of machine learning algorithm that is designed to mimic the behavior of neurons in the human brain. Other examples of ML algorithms include a support vector machine (SVM) algorithm, a random forest algorithm, a naive Bayes algorithm, a K-means clustering algorithm, a neural network algorithm, an artificial neural network (ANN) algorithm, a convolutional neural network (CNN) algorithm, a recurrent neural network (RNN) algorithm, a long short-term memory (LSTM) algorithm, a deep learning algorithm, a decision tree learning algorithm, a regression analysis algorithm, a Bayesian network algorithm, a genetic algorithm, a federated learning algorithm, a distributed artificial intelligence algorithm, and so forth. Embodiments are not limited in this context.

As depicted in FIG. 16, the artificial intelligence architecture 1600 includes a set of data sources 1602 to source data 1604 for the artificial intelligence architecture 1600. Data sources 1602 includes any device capable generating, processing, storing or managing data 1604 suitable for a ML system. Examples of data sources 1602 include without limitation databases, web scraping, sensors and Internet of Things (IoT) devices, image and video cameras, audio devices, text generators, publicly available databases, private databases, and many other data sources 1602. The data sources 1602 may be remote from the artificial intelligence architecture 1600 and accessed via a network, local to the artificial intelligence architecture 1600 an accessed via a network interface, or may be a combination of local and remote data sources 1602.

The data sources 1602 source difference types of data 1604. By way of example and not limitation, the data 1604 includes structured data from relational databases, such as customer profiles, transaction histories, or product inventories. The data 1604 includes unstructured data from websites such as customer reviews, news articles, social media posts, or product specifications. The data 1604 includes data from temperature sensors, motion detectors, and smart home appliances. The data 1604 includes image data from medical images, security footage, or satellite images. The data 1604 includes audio data from speech recognition, music recognition, or call centers. The data 1604 includes text data from emails, chat logs, customer feedback, news articles or social media posts. The data 1604 includes publicly available datasets such as those from government agencies, academic institutions, or research organizations. These are just a few examples of the many sources of data that can be used for ML systems. It is important to note that the quality and quantity of the data is critical for the success of a machine learning project.

The data 1604 is typically in different formats such as structured, unstructured or semi-structured data. Structured data refers to data that is organized in a specific format or schema, such as tables or spreadsheets. Structured data has a well-defined set of rules that dictate how the data should be organized and represented, including the data types and relationships between data elements. Unstructured data refers to any data that does not have a predefined or organized format or schema. Unlike structured data, which is organized in a specific way, unstructured data can take various forms, such as text, images, audio, or video. Unstructured data can come from a variety of sources, including social media, emails, sensor data, and website content. Semi-structured data is a type of data that does not fit neatly into the traditional categories of structured and unstructured data. It has some structure but does not conform to the rigid structure of a traditional relational database. Semi-structured data is characterized by the presence of tags or metadata that provide some structure and context for the data.

The data sources 1602 are communicatively coupled to a data collector 1502. The data collector 1502 gathers relevant data 1604 from the data sources 1602. Once collected, the data collector 1502 may use a pre-processor 1606 to make the data 1604 suitable for analysis. This involves data cleaning, transformation, and feature engineering. Data preprocessing is a critical step in ML as it directly impacts the accuracy and effectiveness of the ML model 1430. The pre-processor 1606 receives the data 1604 as input, processes the data 1604, and outputs pre-processed data 1616 for storage in a database 1608. Examples for the database 1608 includes a hard drive, solid state storage, and/or random access memory (RAM).

The data collector 1502 is communicatively coupled to a model trainer 1504. The model trainer 1504 performs AI/ML model training, validation, and testing which may generate model performance metrics as part of the model testing procedure. The model trainer 1504 receives the pre-processed data 1616 as input 1610 or via the database 1608. The model trainer 1504 implements a suitable ML algorithm 1624 to train an ML model 1430 on a set of training data 1626 from the pre-processed data 1616. The training process involves feeding the pre-processed data 1616 into the ML algorithm 1624 to produce or optimize an ML model 1430. The training process adjusts its parameters until it achieves an initial level of satisfactory performance.

The model trainer 1504 is communicatively coupled to a model evaluator 1506. After an ML model 1430 is trained, the ML model 1430 needs to be evaluated to assess its performance. This is done using various metrics such as accuracy, precision, recall, and F1 score. The model trainer 1504 outputs the ML model 1430, which is received as input 1610 or from the database 1608. The model evaluator 1506 receives the ML model 1430 as input 1612, and it initiates an evaluation process to measure performance of the ML model 1430. The evaluation process includes providing feedback 1618 to the model trainer 1504. The model trainer 1504 re-trains the ML model 1430 to improve performance in an iterative manner.

The model evaluator 1506 is communicatively coupled to a model inferencer 1508. The model inferencer 1508 provides AI/ML model inference output (e.g., inferences, predictions or decisions). Once the ML model 1430 is trained and evaluated, it is deployed in a production environment where it is used to make predictions on new data. The model inferencer 1508 receives the evaluated ML model 1430 as input 1614. The model inferencer 1508 uses the evaluated ML model 1430 to produce insights or predictions on real data, which is deployed as a final production ML model 1430. The inference output of the ML model 1430 is use case specific. The model inferencer 1508 also performs model monitoring and maintenance, which involves continuously monitoring performance of the ML model 1430 in the production environment and making any necessary updates or modifications to maintain its accuracy and effectiveness. The model inferencer 1508 provides feedback 1618 to the data collector 1502 to train or re-train the ML model 1430. The feedback 1618 includes model performance feedback information, which is used for monitoring and improving performance of the ML model 1430.

Some or all of the model inferencer 1508 is implemented by various actors 1622 in the artificial intelligence architecture 1600, including the ML model 1430 of the content creation device 1404, for example. The actors 1622 use the deployed ML model 1430 on new data to make inferences or predictions for a given task, and output an insight 1632. The actors 1622 implement the model inferencer 1508 locally, or remotely receives outputs from the model inferencer 1508 in a distributed computing manner. The actors 1622 trigger actions directed to other entities or to itself. The actors 1622 provide feedback 1620 to the data collector 1502 via the model inferencer 1508. The feedback 1620 comprise data needed to derive training data, inference data or to monitor the performance of the ML model 1430 and its impact to the network through updating of key performance indicators (KPIs) and performance counters.

As previously described with reference to FIGS. 1-11, the systems 1400, 1500 implement some or all of the artificial intelligence architecture 1600 to support various use cases and solutions for various AI/ML tasks. In various embodiments, the training device 1514 of the apparatus 1500 uses the artificial intelligence architecture 1600 to generate and train the ML model 1430 for use by the content creation device 1404 for the system 1400. In one embodiment, for example, the training device 1514 may train the ML model 1430 as a neural network, as described in more detail with reference to FIG. 15. Other use cases and solutions for AI/ML are possible as well, and embodiments are not limited in this context.

FIG. 17 illustrates an embodiment of an artificial neural network 1700. Neural networks, also known as artificial neural networks (ANNs) or simulated neural networks (SNNs), are a subset of machine learning and are at the core of deep learning algorithms. Their name and structure are inspired by the human brain, mimicking the way that biological neurons signal to one another.

Artificial neural network 1700 comprises multiple node layers, containing an input layer 1726, one or more hidden layers 1728, and an output layer 1730. Each layer comprises one or more nodes, such as nodes 1702 to 1724. As depicted in FIG. 17, for example, the input layer 1726 has nodes 1702, 1704. The artificial neural network 1700 has two hidden layers 1728, with a first hidden layer having nodes 1706, 1708, 1710 and 1712, and a second hidden layer having nodes 1714, 1716, 1718 and 1720. The artificial neural network 1700 has an output layer 1730 with nodes 1722, 1724. Each node 1702 to 1724 comprises a processing element (PE), or artificial neuron, that connects to another and has an associated weight and threshold. If the output of any individual node is above the specified threshold value, that node is activated, sending data to the next layer of the network. Otherwise, no data is passed along to the next layer of the network.

In general, artificial neural network 1700 relies on training data 1626 to learn and improve accuracy over time. However, once the artificial neural network 1700 is fine-tuned for accuracy, and tested on testing data 1628, the artificial neural network 1700 is ready to classify and cluster new data 1630 at a high velocity. Tasks in speech recognition or image recognition can take minutes versus hours when compared to the manual identification by human experts.

Each individual node 1702 to 1724 is a linear regression model, composed of input data, weights, a bias (or threshold), and an output. The linear regression model may have a formula the same or similar to the following Equation (1):

$$\sum {w}_{i} {x}_{i} + bias = {w}_{1} {x}_{1} + {w}_{2} {x}_{2} + {w}_{3} {x}_{3} + bias$$

$$output = f ( x ) = 1 if \sum {w}_{1} {x}_{1} + b >= 0 ; 0 if \sum {w}_{1} {x}_{1} + b < 0.$$

Once an input layer 1726 is determined, a set of weights 1732 are assigned. The weights 1732 help determine the importance of any given variable, with larger ones contributing more significantly to the output compared to other inputs. All inputs are then multiplied by their respective weights and then summed. Afterward, the output is passed through an activation function, which determines the output. If that output exceeds a given threshold, it “fires” (or activates) the node, passing data to the next layer in the network. This results in the output of one node becoming in the input of the next node. The process of passing data from one layer to the next layer defines the artificial neural network 1700 as a feedforward network.

In one embodiment, the artificial neural network 1700 leverages sigmoid neurons, which are distinguished by having values between 0 and 1. Since the artificial neural network 1700 behaves similarly to a decision tree, cascading data from one node to another, having x values between 0 and 1 will reduce the impact of any given change of a single variable on the output of any given node, and subsequently, the output of the artificial neural network 1700.

The artificial neural network 1700 has many practical use cases, like image recognition, speech recognition, text recognition or classification. The artificial neural network 1700 leverages supervised learning, or labeled datasets, to train the algorithm. As the model is trained, its accuracy is measured using a cost (or loss) function. This is also commonly referred to as the mean squared error (MSE). An example of a cost function is shown in the following Equation (2):

$$Cost Function = M S E = \frac{1}{2 m} {\sum }_{{i = 1}_{}}^{m} {( \hat{{y}_{1}} - {y}_{i} )}^{2} \to MIN ,$$

where i represents the index of the sample, y-hat is the predicted outcome, y is the actual value, and m is the number of samples.

Ultimately, the goal is to minimize the cost function to ensure correctness of fit for any given observation. As the model adjusts its weights and bias, it uses the cost function and reinforcement learning to reach the point of convergence, or the local minimum. The process in which the algorithm adjusts its weights is through gradient descent, allowing the model to determine the direction to take to reduce errors (or minimize the cost function). With each training example, the parameters 1734 of the model adjust to gradually converge at the minimum.

In one embodiment, the artificial neural network 1700 is feedforward, meaning it flows in one direction only, from input to output. In one embodiment, the artificial neural network 1700 uses backpropagation. Backpropagation is when the artificial neural network 1700 moves in the opposite direction from output to input. Backpropagation allows calculation and attribution of errors associated with each neuron 1702 to 1724, thereby allowing adjustment to fit the parameters 1734 of the ML model 1430 appropriately.

The artificial neural network 1700 is implemented as different neural networks depending on a given task. Neural networks are classified into different types, which are used for different purposes. In one embodiment, the artificial neural network 1700 is implemented as a feedforward neural network, or multi-layer perceptrons (MLPs), comprised of an input layer 1726, hidden layers 1728, and an output layer 1730. While these neural networks are also commonly referred to as MLPs, they are actually comprised of sigmoid neurons, not perceptrons, as most real-world problems are nonlinear. Trained data 1604 usually is fed into these models to train them, and they are the foundation for computer vision, natural language processing, and other neural networks. In one embodiment, the artificial neural network 1700 is implemented as a convolutional neural network (CNN). A CNN is similar to feedforward networks, but usually utilized for image recognition, pattern recognition, and/or computer vision. These networks harness principles from linear algebra, particularly matrix multiplication, to identify patterns within an image. In one embodiment, the artificial neural network 1700 is implemented as a recurrent neural network (RNN). A RNN is identified by feedback loops. The RNN learning algorithms are primarily leveraged when using time-series data to make predictions about future outcomes, such as stock market predictions or sales forecasting. The artificial neural network 1700 is implemented as any type of neural network suitable for a given operational task of system 1400, and the MLP, CNN, GNN, HNN, HGNN, and RNN are merely a few examples. Embodiments are not limited in this context.

The artificial neural network 1700 includes a set of associated parameters 1734. There are a number of different parameters that must be decided upon when designing a neural network. Among these parameters are the number of layers, the number of neurons per layer, the number of training iterations, and so forth. Some of the more important parameters in terms of training and network capacity are a number of hidden neurons parameter, a learning rate parameter, a momentum parameter, a training type parameter, an Epoch parameter, a minimum error parameter, and so forth.

In some cases, the artificial neural network 1700 is implemented as a deep learning neural network. The term deep learning neural network refers to a depth of layers in a given neural network. A neural network that has more than three layers-which would be inclusive of the inputs and the output—can be considered a deep learning algorithm. A neural network that only has two or three layers, however, may be referred to as a basic neural network. A deep learning neural network may tune and optimize one or more hyperparameters 1736. A hyperparameter is a parameter whose values are set before starting the model training process. Deep learning models, including convolutional neural network (CNN) and recurrent neural network (RNN) models can have anywhere from a few hyperparameters to a few hundred hyperparameters. The values specified for these hyperparameters impacts the model learning rate and other regulations during the training process as well as final model performance. A deep learning neural network uses hyperparameter optimization algorithms to automatically optimize models. The algorithms used include Random Search, Tree-structured Parzen Estimator (TPE) and Bayesian optimization based on the Gaussian process. These algorithms are combined with a distributed training engine for quick parallel searching of the optimal hyperparameter values.

FIG. 18 illustrates an apparatus 1800. Apparatus 1800 comprises any non-transitory computer-readable storage medium 1802 or machine-readable storage medium, such as an optical, magnetic or semiconductor storage medium. In various embodiments, apparatus 1800 comprises an article of manufacture or a product. In some embodiments, the computer-readable storage medium 1802 stores computer executable instructions with which one or more processing devices or processing circuitry can execute. For example, computer executable instructions 1804 includes instructions to implement operations described with respect to any logic flows described herein. Examples of computer-readable storage medium 1802 or machine-readable storage medium include any tangible media capable of storing electronic data, including volatile memory or non-volatile memory, removable or non-removable memory, erasable or non-erasable memory, writeable or re-writeable memory, and so forth. Examples of computer executable instructions 1804 include any suitable type of code, such as source code, compiled code, interpreted code, executable code, static code, dynamic code, object-oriented code, visual code, and the like.

FIG. 19 illustrates an embodiment of a computing architecture 1900. Computing architecture 1900 is a computer system with multiple processor cores such as a distributed computing system, supercomputer, high-performance computing system, computing cluster, mainframe computer, mini-computer, client-server system, personal computer (PC), workstation, server, portable computer, laptop computer, tablet computer, handheld device such as a personal digital assistant (PDA), or other device for processing, displaying, or transmitting information. Similar embodiments may comprise, e.g., entertainment devices such as a portable music player or a portable video player, a smart phone or other cellular phone, a telephone, a digital video camera, a digital still camera, an external storage device, or the like. Further embodiments implement larger scale server configurations. In other embodiments, the computing architecture 1900 has a single processor with one core or more than one processor. Note that the term “processor” refers to a processor with a single core or a processor package with multiple processor cores. In at least one embodiment, the computing architecture 1900 is representative of the components of the system 1200. More generally, the computing architecture 1900 implements all logic, systems, logic flows, methods, apparatuses, and functionality described herein with reference to previous figures.

As used in this application, the terms “system” and “component” and “module” are intended to refer to a computer-related entity, either hardware, a combination of hardware and software, software, or software in execution, examples of which are provided by the exemplary computing architecture 1900. For example, a component is, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server are a component. One or more components reside within a process and/or thread of execution, and a component is localized on one computer and/or distributed between two or more computers. Further, components are communicatively coupled to each other by various types of communications media to coordinate operations. The coordination involves the uni-directional or bi-directional exchange of information. For instance, the components communicate information in the form of signals communicated over the communications media. The information is implemented as signals allocated to various signal lines. In such allocations, each message is a signal. Further embodiments, however, alternatively employ data messages. Such data messages may be sent across various connections. Exemplary connections include parallel interfaces, serial interfaces, and bus interfaces.

As shown in FIG. 19, computing architecture 1900 comprises a system-on-chip (SoC) 1902 for mounting platform components. System-on-chip (SoC) 1902 is a point-to-point (P2P) interconnect platform that includes a first processor 1904 and a second processor 1906 coupled via a point-to-point interconnect 1970 such as an Ultra Path Interconnect (UPI). In other embodiments, the computing architecture 1900 is another bus architecture, such as a multi-drop bus. Furthermore, each of processor 1904 and processor 1906 are processor packages with multiple processor cores including core(s) 1908 and core(s) 1910, respectively. While the computing architecture 1900 is an example of a two-socket (2S) platform, other embodiments include more than two sockets or one socket. For example, some embodiments include a four-socket (4S) platform or an eight-socket (8S) platform. Each socket is a mount for a processor and may have a socket identifier. Note that the term platform refers to a motherboard with certain components mounted such as the processor 1904 and chipset 1932. Some platforms include additional components and some platforms include sockets to mount the processors and/or the chipset. Furthermore, some platforms do not have sockets (e.g. SoC, or the like). Although depicted as a SoC 1902, one or more of the components of the SoC 1902 are included in a single die package, a multi-chip module (MCM), a multi-die package, a chiplet, a bridge, and/or an interposer. Therefore, embodiments are not limited to a SoC.

The processor 1904 and processor 1906 are any commercially available processors, including without limitation an Intel® Celeron®, Core®, Core (2) Duo®, Itanium®, Pentium®, Xeon®, and XScale® processors; AMD® Athlon®, Duron® and Opteron® processors; ARM® application, embedded and secure processors; IBM® and Motorola® DragonBall® and PowerPC® processors; IBM and Sony® Cell processors; and similar processors. Dual microprocessors, multi-core processors, and other multi-processor architectures are also employed as the processor 1904 and/or processor 1906. Additionally, the processor 1904 need not be identical to processor 1906.

Processor 1904 includes an integrated memory controller (IMC) 1920 and point-to-point (P2P) interface 1924 and P2P interface 1928. Similarly, the processor 1906 includes an IMC 1922 as well as P2P interface 1926 and P2P interface 1930. IMC 1920 and IMC 1922 couple the processor 1904 and processor 1906, respectively, to respective memories (e.g., memory 1916 and memory 1918). Memory 1916 and memory 1918 are portions of the main memory (e.g., a dynamic random-access memory (DRAM)) for the platform such as double data rate type 4 (DDR4) or type 5 (DDR5) synchronous DRAM (SDRAM). In the present embodiment, the memory 1916 and the memory 1918 locally attach to the respective processors (i.e., processor 1904 and processor 1906). In other embodiments, the main memory couple with the processors via a bus and shared memory hub. Processor 1904 includes registers 1912 and processor 1906 includes registers 1914.

Computing architecture 1900 includes chipset 1932 coupled to processor 1904 and processor 1906. Furthermore, chipset 1932 are coupled to storage device 1950, for example, via an interface (I/F) 1938. The I/F 1938 may be, for example, a Peripheral Component Interconnect-enhanced (PCIe) interface, a Compute Express Link® (CXL) interface, or a Universal Chiplet Interconnect Express (UCIe) interface. Storage device 1950 stores instructions executable by circuitry of computing architecture 1900 (e.g., processor 1904, processor 1906, GPU 1948, accelerator 1954, vision processing unit 1956, or the like). For example, storage device 1950 can store instructions for the client device 1202, the client device 1206, the content creation device 1404, the training device 1314, or the like.

Processor 1904 couples to the chipset 1932 via P2P interface 1928 and P2P 1934 while processor 1906 couples to the chipset 1932 via P2P interface 1930 and P2P 1936. Direct media interface (DMI) 1976 and DMI 1978 couple the P2P interface 1928 and the P2P 1934 and the P2P interface 1930 and P2P 1936, respectively. DMI 1976 and DMI 1978 is a high-speed interconnect that facilitates, e.g., eight Giga Transfers per second (GT/s) such as DMI 3.0. In other embodiments, the processor 1904 and processor 1906 interconnect via a bus.

The chipset 1932 comprises a controller hub such as a platform controller hub (PCH). The chipset 1932 includes a system clock to perform clocking functions and include interfaces for an I/O bus such as a universal serial bus (USB), peripheral component interconnects (PCIs), CXL interconnects, UCIe interconnects, interface serial peripheral interconnects (SPIs), integrated interconnects (I2Cs), and the like, to facilitate connection of peripheral devices on the platform. In other embodiments, the chipset 1932 comprises more than one controller hub such as a chipset with a memory controller hub, a graphics controller hub, and an input/output (I/O) controller hub.

In the depicted example, chipset 1932 couples with a trusted platform module (TPM) 1944 and UEFI, BIOS, FLASH circuitry 1946 via I/F 1942. The TPM 1944 is a dedicated microcontroller designed to secure hardware by integrating cryptographic keys into devices. The UEFI, BIOS, FLASH circuitry 1946 may provide pre-boot code. The I/F 1942 may also be coupled to a network interface circuit (NIC) 1980 for connections off-chip.

Furthermore, chipset 1932 includes the I/F 1938 to couple chipset 1932 with a high-performance graphics engine, such as, graphics processing circuitry or a graphics processing unit (GPU) 1948. In other embodiments, the computing architecture 1900 includes a flexible display interface (FDI) (not shown) between the processor 1904 and/or the processor 1906 and the chipset 1932. The FDI interconnects a graphics processor core in one or more of processor 1904 and/or processor 1906 with the chipset 1932.

The computing architecture 1900 is operable to communicate with wired and wireless devices or entities via the network interface (NIC) 200 using the IEEE 802 family of standards, such as wireless devices operatively disposed in wireless communication (e.g., IEEE 802.11 over-the-air modulation techniques). This includes at least Wi-Fi (or Wireless Fidelity), WiMax, and Bluetooth™ wireless technologies, 3G, 4G, LTE wireless technologies, among others. Thus, the communication is a predefined structure as with a conventional network or simply an ad hoc communication between at least two devices. Wi-Fi networks use radio technologies called IEEE 802.11x (a, b, g, n, ac, ax, etc.) to provide secure, reliable, fast wireless connectivity. A Wi-Fi network is used to connect computers to each other, to the Internet, and to wired networks (which use IEEE 802.3-related media and functions).

Additionally, accelerator 1954 and/or vision processing unit 1956 are coupled to chipset 1932 via I/F 1938. The accelerator 1954 is representative of any type of accelerator device (e.g., a data streaming accelerator, cryptographic accelerator, cryptographic co-processor, an offload engine, etc.). One example of an accelerator 1954 is the Intel® Data Streaming Accelerator (DSA). The accelerator 1954 is a device including circuitry to accelerate copy operations, data encryption, hash value computation, data comparison operations (including comparison of data in memory 1916 and/or memory 1918), and/or data compression. Examples for the accelerator 1954 include a USB device, PCI device, PCIe device, CXL device, UCIe device, and/or an SPI device. The accelerator 1954 also includes circuitry arranged to execute machine learning (ML) related operations (e.g., training, inference, etc.) for ML models. Generally, the accelerator 1954 is specially designed to perform computationally intensive operations, such as hash value computations, comparison operations, cryptographic operations, and/or compression operations, in a manner that is more efficient than when performed by the processor 1904 or processor 1906. Because the load of the computing architecture 1900 includes hash value computations, comparison operations, cryptographic operations, and/or compression operations, the accelerator 1954 greatly increases performance of the computing architecture 1900 for these operations.

The accelerator 1954 includes one or more dedicated work queues and one or more shared work queues (each not pictured). Generally, a shared work queue is stores descriptors submitted by multiple software entities. The software is any type of executable code, such as a process, a thread, an application, a virtual machine, a container, a microservice, etc., that share the accelerator 1954. For example, the accelerator 1954 is shared according to the Single Root I/O virtualization (SR-IOV) architecture and/or the Scalable I/O virtualization (S-IOV) architecture. Embodiments are not limited in these contexts. In some embodiments, software uses an instruction to atomically submit the descriptor to the accelerator 1954 via a non-posted write (e.g., a deferred memory write (DMWr)). One example of an instruction that atomically submits a work descriptor to the shared work queue of the accelerator 1954 is the ENQCMD command or instruction (which may be referred to as “ENQCMD” herein) supported by the Intel® Instruction Set Architecture (ISA). However, any instruction having a descriptor that includes indications of the operation to be performed, a source virtual address for the descriptor, a destination virtual address for a device-specific register of the shared work queue, virtual addresses of parameters, a virtual address of a completion record, and an identifier of an address space of the submitting process is representative of an instruction that atomically submits a work descriptor to the shared work queue of the accelerator 1954. The dedicated work queue may accept job submissions via commands such as the movdir64b instruction.

Various I/O devices 1960 and display 1952 couple to the bus 1972, along with a bus bridge 1958 which couples the bus 1972 to a second bus 1974 and an I/F 1940 that connects the bus 1972 with the chipset 1932. In one embodiment, the second bus 1974 is a low pin count (LPC) bus. Various input/output (I/O) devices couple to the second bus 1974 including, for example, a keyboard 1962, a mouse 1964 and communication devices 1966.

Furthermore, an audio I/O 1968 couples to second bus 1974. Many of the I/O devices 1960 and communication devices 1966 reside on the system-on-chip (SoC) 1902 while the keyboard 1962 and the mouse 1964 are add-on peripherals. In other embodiments, some or all the I/O devices 1960 and communication devices 1966 are add-on peripherals and do not reside on the system-on-chip (SoC) 1902.

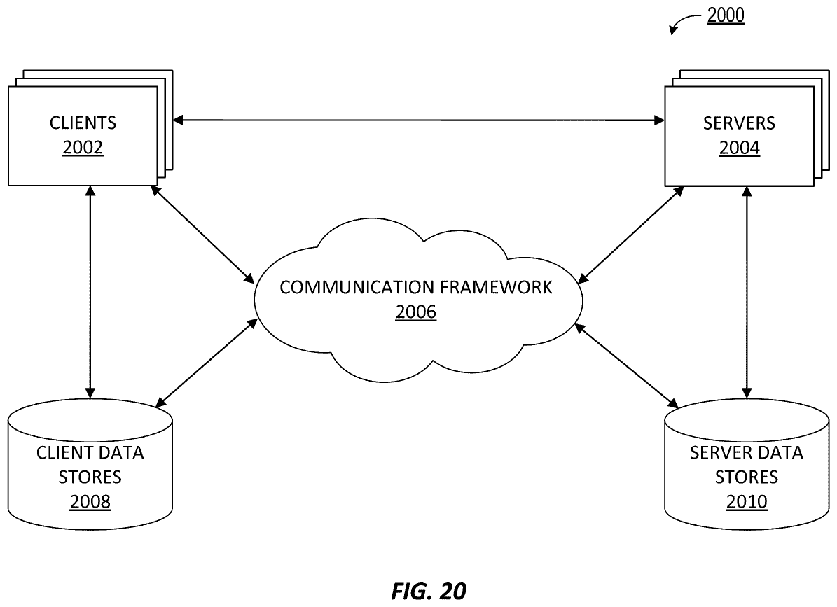

FIG. 20 illustrates a block diagram of an exemplary communications architecture 2000 suitable for implementing various embodiments as previously described. The communications architecture 2000 includes various common communications elements, such as a transmitter, receiver, transceiver, radio, network interface, baseband processor, antenna, amplifiers, filters, power supplies, and so forth. The embodiments, however, are not limited to implementation by the communications architecture 2000.

As shown in FIG. 20, the communications architecture 2000 includes one or more clients 2002 and servers 2004. The clients 2002 and the servers 2004 are operatively connected to one or more respective client data stores 2008 and server data stores 2010 that can be employed to store information local to the respective clients 2002 and servers 2004, such as cookies and/or associated contextual information.

The clients 2002 and the servers 2004 communicate information between each other using a communication framework 2006. The communication framework 2006 implements any well-known communications techniques and protocols. The communication framework 2006 is implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communication framework 2006 implements various network interfaces arranged to accept, communicate, and connect to a communications network. A network interface is regarded as a specialized form of an input output interface. Network interfaces employ connection protocols including without limitation direct connect, Ethernet (e.g., thick, thin, twisted pair 10/1200/1000 Base T, and the like), token ring, wireless network interfaces, cellular network interfaces, IEEE 802.11 network interfaces, IEEE 802.16 network interfaces, IEEE 802.20 network interfaces, and the like. Further, multiple network interfaces are used to engage with various communications network types. For example, multiple network interfaces are employed to allow for the communication over broadcast, multicast, and unicast networks. Should processing requirements dictate a greater amount speed and capacity, distributed network controller architectures are similarly employed to pool, load balance, and otherwise increase the communicative bandwidth required by clients 2002 and the servers 2004. A communications network is any one and the combination of wired and/or wireless networks including without limitation a direct interconnection, a secured custom connection, a private network (e.g., an enterprise intranet), a public network (e.g., the Internet), a Personal Area Network (PAN), a Local Area Network (LAN), a Metropolitan Area Network (MAN), an Operating Missions as Nodes on the Internet (OMNI), a Wide Area Network (WAN), a wireless network, a cellular network, and other communications networks.

The various elements of the devices as previously described with reference to the figures include various hardware elements, software elements, or a combination of both. Examples of hardware elements include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements varies in accordance with any number of factors, such as desired computational rate, power levels, heat tolerances, processing cycle budget, input data rates, output data rates, memory resources, data bus speeds and other design or performance constraints, as desired for a given implementation.

One or more aspects of at least one embodiment are implemented by representative instructions stored on a machine-readable medium which represents various logic within the processor, which when read by a machine causes the machine to fabricate logic to perform the techniques described herein. Such representations, known as “intellectual property (IP) cores” are stored on a tangible, machine readable medium and supplied to various customers or manufacturing facilities to load into the fabrication machines that make the logic or processor. Some embodiments are implemented, for example, using a machine-readable medium or article which may store an instruction or a set of instructions that, when executed by a machine, causes the machine to perform a method and/or operations in accordance with the embodiments. Such a machine includes, for example, any suitable processing platform, computing platform, computing device, processing device, computing system, processing system, processing devices, computer, processor, or the like, and is implemented using any suitable combination of hardware and/or software. The machine-readable medium or article includes, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions include any suitable type of code, such as source code, compiled code, interpreted code, executable code, static code, dynamic code, encrypted code, and the like, implemented using any suitable high-level, low-level, object-oriented, visual, compiled and/or interpreted programming language.

In one embodiment, a computer-implemented method includes determining, via a content generation module, content generation information from a user prompt, the content generation information comprising at least one subject, at least one audience segment, and at least one performance indicator, and providing, via the content generation module, the content generation information to a content generation model to generate at least one item of audience-targeted content corresponding to the at least one subject targeted to the at least one audience segment to elicit a response defined by the at least one performance indicator, the content generation module includes a natural language processing (NLP) model trained, via a content generation training module, using reinforcement learning based on a reward of a performance prediction determined by a performance prediction model based on historical performance data.

In some examples of the method, the audience-targeted content includes an email, and the at least one performance indicator is at least one key performance indicator (KPI) for the email.

In various examples of the method, the at least one audience segment includes a plurality of audience segments, the at least one item of audience-targeted content includes a plurality of items of content, each of the plurality of items of content are configured for a specific one of the plurality of audience segments.

In some examples of the method, the user prompt comprising a text-based prompt having a subject definition, a segment definition, and a performance objective definition.

In various examples of the method, the performance prediction includes a numerical value indicating a probability of a recipient of the item of audience-targeted content for the at least one audience segment to perform the performance objective.

In some examples of the method, the NLP model comprising a base large language model (LLM) pre-trained using instruction-based training.

In various examples of the method, the reinforcement learning includes providing the user prompt to the base LLM to determine at least one base item of content, and determining a divergence between the at least one item of audience-targeted content and the at least one base item of content.

In one embodiment, a system includes at least one processor and at least one non-transitory storage media storing instructions. The instructions, when executed by the at least one processor, to cause the at least one processor to perform operations including performing a first training, using a performance training module, of a performance prediction model based on training data including a triad of historical content, audience segment, and performance data, the first training to configure the performance prediction model to generate a performance prediction indicating the predict key performance indicator (KPI) performance of an item of content for an audience segment, and performing a second training, using a content generation training module, including reinforcement learning of a base natural language processing (NLP) model using the performance prediction as a reward of the reinforcement learning, the second training to configure the base NLP model as a content generation model configured to generate at least one item of audience-targeted content based on a user prompt.

In some examples of the system, performing the first training including providing content training data to a content NLP model to generate content encodings, and providing segment training data to a segment NLP model to generate segment encodings.

In various examples of the system, performing the first training including providing performance training data to a performance network model to generate performance encodings.

In some examples of the system, performing the first training including providing the content encodings to a content network model to generate second content encodings, and providing the segment encodings to a segment network model to generate second segment encodings,

In various examples of the system, the performance network model, the content network model, and the segment network model including a multi-layer perceptron (MLP).

In some examples of the system, the first training including aggregating the performance encodings, second content encodings, and second segment encodings into an encoding aggregate, and providing the encoding aggregate to the performance prediction model as the training data to train the performance prediction model to generate the performance prediction.

In various examples of the system, the base NLP model including a base LLM trained using instruction-based training.

In some examples of the system, the reinforcement learning includes providing the user prompt to the base LLM to determine at least one base item of content, and determining a divergence between the at least one item of audience-targeted content and the at least one base item of content.

In one embodiment, a non-transitory computer-readable medium stores executable instructions, which when executed by one or more processing devices, cause the one or more processing devices to perform operations including: determining, via a content generation module, content generation information from a user prompt, the content generation information comprising at least one subject, at least one audience segment, and at least one performance indicator, and providing, via the content generation module, the content generation information to a content generation model to generate at least one item of audience-targeted content corresponding to the at least one subject targeted to the at least one audience segment to elicit a response defined by the at least one performance indicator, wherein the content generation module comprises a natural language processing (NLP) model trained, via a content generation training module, using reinforcement learning based on a reward of a performance prediction determined by a performance prediction model based on historical performance data.

In some examples of the non-transitory computer-readable medium, the audience-targeted content includes an email, and the at least one performance indicator is at least one key performance indicator (KPI) for the email.

In some examples of the non-transitory computer-readable medium, the at least one audience segment includes a plurality of audience segments, the at least one item of audience-targeted content includes a plurality of items of content, and each of the plurality of items of content are configured for a specific one of the plurality of audience segments.

In some examples of the non-transitory computer-readable medium, the performance prediction includes a numerical value indicating a probability of a recipient of the item of audience-targeted content for the at least one audience segment to perform the performance objective.

In some examples of the non-transitory computer-readable medium, the NLP model comprising a base large language model (LLM) pre-trained using instruction-based training, and the reinforcement learning includes providing the user prompt to the base LLM to determine at least one base item of content, and determining a divergence between the at least one item of audience-targeted content and the at least one base item of content.

As utilized herein, terms “component,” “system,” “interface,” and the like are intended to refer to a computer-related entity, hardware, software (e.g., in execution), and/or firmware. For example, a component is a processor (e.g., a microprocessor, a controller, or other processing device), a process running on a processor, a controller, an object, an executable, a program, a storage device, a computer, a tablet PC and/or a user equipment (e.g., mobile phone, etc.) with a processing device. By way of illustration, an application running on a server and the server is also a component. One or more components reside within a process, and a component is localized on one computer and/or distributed between two or more computers. A set of elements or a set of other components are described herein, in which the term “set” can be interpreted as “one or more.”

Further, these components execute from various computer readable storage media having various data structures stored thereon such as with a module, for example. The components communicate via local and/or remote processes such as in accordance with a signal having one or more data packets (e.g., data from one component interacting with another component in a local system, distributed system, and/or across a network, such as, the Internet, a local area network, a wide area network, or similar network with other systems via the signal).

As another example, a component is an apparatus with specific functionality provided by mechanical parts operated by electric or electronic circuitry, in which the electric or electronic circuitry is operated by a software application or a firmware application executed by one or more processors. The one or more processors are internal or external to the apparatus and execute at least a part of the software or firmware application. As yet another example, a component is an apparatus that provides specific functionality through electronic components without mechanical parts; the electronic components include one or more processors therein to execute software and/or firmware that confer(s), at least in part, the functionality of the electronic components.

Use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description and the claims, such terms are intended to be inclusive in a manner similar to the term “comprising.” Additionally, in situations wherein one or more numbered items are discussed (e.g., a “first X”, a “second X”, etc.), in general the one or more numbered items may be distinct or they may be the same, although in some situations the context may indicate that they are distinct or that they are the same.

As used herein, the term “circuitry” may refer to, be part of, or include a circuit, an integrated circuit (IC), a monolithic IC, a discrete circuit, a hybrid integrated circuit (HIC), an Application Specific Integrated Circuit (ASIC), an electronic circuit, a logic circuit, a microcircuit, a hybrid circuit, a microchip, a chip, a chiplet, a chipset, a multi-chip module (MCM), a semiconductor die, a system on a chip (SoC), a processor (shared, dedicated, or group), a processor circuit, a processing circuit, or associated memory (shared, dedicated, or group) operably coupled to the circuitry that execute one or more software or firmware programs, a combinational logic circuit, or other suitable hardware components that provide the described functionality. In some embodiments, the circuitry is implemented in, or functions associated with the circuitry are implemented by, one or more software or firmware modules. In some embodiments, circuitry includes logic, at least partially operable in hardware. It is noted that hardware, firmware and/or software elements may be collectively or individually referred to herein as “logic” or “circuit.”

Some embodiments are described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Moreover, unless otherwise noted the features described above are recognized to be usable together in any combination. Thus, any features discussed separately can be employed in combination with each other unless it is noted that the features are incompatible with each other.

Some embodiments are presented in terms of program procedures executed on a computer or network of computers. A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein, which form part of one or more embodiments. Rather, the operations are machine operations. Useful machines for performing operations of various embodiments include general purpose digital computers or similar devices.

Some embodiments are described using the expression “coupled” and “connected” along with their derivatives. These terms are not necessarily intended as synonyms for each other. For example, some embodiments are described using the terms “connected” and/or “coupled” to indicate that two or more elements are in direct physical or electrical contact with each other. The term “coupled,” however, also means that two or more elements are not in direct contact with each other, but yet still co-operate or interact with each other.

Various embodiments also relate to apparatus or systems for performing these operations. This apparatus is specially constructed for the required purpose or it comprises a general purpose computer as selectively activated or reconfigured by a computer program stored in the computer. The procedures presented herein are not inherently related to a particular computer or other apparatus. Various general purpose machines are used with programs written in accordance with the teachings herein, or it proves convenient to construct more specialized apparatus to perform the required method steps. The required structure for a variety of these machines are apparent from the description given.

It is emphasized that the Abstract of the Disclosure is provided to allow a reader to quickly ascertain the nature of the technical disclosure. It is submitted with the understanding that it will not be used to interpret or limit the scope or meaning of the claims. In addition, the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects. The following examples pertain to further embodiments, from which numerous permutations and configurations will be apparent.

What is claimed is:

1. A computer-implemented method, comprising:
determining, via a content generation module, content generation information from a user prompt, the content generation information comprising at least one subject, at least one audience segment, and at least one performance indicator; and
providing, via the content generation module, the content generation information to a content generation model to generate at least one item of audience-targeted content corresponding to the at least one subject targeted to the at least one audience segment to elicit a response defined by the at least one performance indicator, wherein the content generation module comprises a natural language processing (NLP) model trained, via a content generation training module, using reinforcement learning based on a reward of a performance prediction determined by a performance prediction model based on historical performance data.

2. The method of claim 1, wherein the audience-targeted content comprises an email, and the at least one performance indicator is at least one key performance indicator (KPI) for the email.

3. The method of claim 1, wherein the at least one audience segment comprises a plurality of audience segments, the at least one item of audience-targeted content comprises a plurality of items of content, wherein each of the plurality of items of content are configured for a specific one of the plurality of audience segments.

4. The method of claim 1, the user prompt comprising a text-based prompt having a subject definition, a segment definition, and a performance objective definition.

5. The method of claim 1, wherein the performance prediction comprises a numerical value indicating a probability of a recipient of the item of audience-targeted content for the at least one audience segment to perform the performance objective.

6. The method of claim 1, wherein the NLP model comprising a base large language model (LLM) pre-trained using instruction-based training.

7. The method of claim 1, wherein the reinforcement learning comprises:
providing the user prompt to the base LLM to determine at least one base item of content; and
determining a divergence between the at least one item of audience-targeted content and the at least one base item of content.

8. A system, comprising:
at least one processor; and
at least one non-transitory storage media storing instructions, that when executed by the at least one processor, cause the at least one processor to perform operations including:
performing a first training, using a performance training module, of a performance prediction model based on training data comprising a triad of historical content, audience segment, and performance data, the first training to configure the performance prediction model to generate a performance prediction indicating the predict key performance indicator (KPI) performance of an item of content for an audience segment, and
performing a second training, using a content generation training module, comprising reinforcement learning of a base natural language processing (NLP) model using the performance prediction as a reward of the reinforcement learning, the second training to configure the base NLP model as a content generation model configured to generate at least one item of audience-targeted content based on a user prompt.

9. The system of claim 8, performing the first training comprising:
providing content training data to a content NLP model to generate content encodings, and
providing segment training data to a segment NLP model to generate segment encodings.

10. The system of claim 8, performing the first training comprising providing performance training data to a performance network model to generate performance encodings.

11. The system of claim 10, performing the first training comprising:
providing the content encodings to a content network model to generate second content encodings, and
providing the segment encodings to a segment network model to generate second segment encodings,

12. The system of claim 11, the performance network model, the content network model, and the segment network model comprising a multi-layer perceptron (MLP).

13. The system of claim 11, wherein the first training comprises:
aggregating the performance encodings, second content encodings, and second segment encodings into an encoding aggregate, and
providing the encoding aggregate to the performance prediction model as the training data to train the performance prediction model to generate the performance prediction.

14. The system of claim 8, the base NLP model comprising a base LLM trained using instruction-based training.

15. The system of claim 14, wherein the reinforcement learning comprises:
providing the user prompt to the base LLM to determine at least one base item of content; and
determining a divergence between the at least one item of audience-targeted content and the at least one base item of content.

16. A non-transitory computer-readable medium storing executable instructions, which when executed by one or more processing devices, cause the one or more processing devices to perform operations comprising:
determining, via a content generation module, content generation information from a user prompt, the content generation information comprising at least one subject, at least one audience segment, and at least one performance indicator; and
providing, via the content generation module, the content generation information to a content generation model to generate at least one item of audience-targeted content corresponding to the at least one subject targeted to the at least one audience segment to elicit a response defined by the at least one performance indicator, wherein the content generation module comprises a natural language processing (NLP) model trained, via a content generation training module, using reinforcement learning based on a reward of a performance prediction determined by a performance prediction model based on historical performance data.

17. The non-transitory computer-readable medium of claim 16, wherein the audience-targeted content comprises an email, and the at least one performance indicator is at least one key performance indicator (KPI) for the email.

18. The non-transitory computer-readable medium of claim 16, wherein the at least one audience segment comprises a plurality of audience segments, the at least one item of audience-targeted content comprises a plurality of items of content, wherein each of the plurality of items of content are configured for a specific one of the plurality of audience segments.

19. The non-transitory computer-readable medium of claim 16, wherein the performance prediction comprises a numerical value indicating a probability of a recipient of the item of audience-targeted content for the at least one audience segment to perform the performance objective.

20. The non-transitory computer-readable medium of claim 16, wherein the NLP model comprising a base large language model (LLM) pre-trained using instruction-based training,
wherein the reinforcement learning comprises:
providing the user prompt to the base LLM to determine at least one base item of content; and
determining a divergence between the at least one item of audience-targeted content and the at least one base item of content.
